(19) United States
(12) Patent Application Publication
(10) Pub. No.: US 2025/0091300 A1
(43) Pub. Date: Mar. 20, 2025

(54) Tube Mandrel and Methods for Forming a Tube

(71) Applicant: Celanese International Corporation, Irving, TX (US)

(72) Inventor: Jeffrey Smith, Hinckley, OH (US)

(21) Appl. No.: 18/883,330

(22) Filed: Sep. 12, 2024

Related U.S. Application Data
(60) Provisional application No. 63/582,538, filed on Sep. 14, 2023.

(51) Int. Cl. B29C 67/00; B21D 9/01; B29C 35/04; B29C 35/08; B29L 23/00

(52) U.S. Cl. CPC B29C 67/0022; B21D 9/01; B29C 35/045; B29C 35/049; B29C 35/0805; B29C 2035/0822; B29L 2023/001

(57) ABSTRACT

A mandrel for the manufacture of a tube is provided. The mandrel includes one or more discs spaced apart from each other; one or more guide wires coupled to one or more of the discs; and one or more control wires coupled to one or more of the discs. Articulation of one or more of the control wires induces a shape change in the tube. Methods for manufacturing a tube are also provided.

### CROSS-REFERENCE TO RELATED APPLICATION

This application claims filing benefit of U.S. Provisional Patent Application No. 63/582,538 having a filing date of Sep. 14, 2023, which is hereby incorporated by reference in its entirety.

### BACKGROUND

Tubes, such as hoses, can be formed from a variety of materials and utilized in several industries including transportation, aerospace, industrial, consumer products, and healthcare. For instance, tubes for vehicles, including electric vehicles, are formed from a variety of materials, and can be used to transport fluids within the vehicle. For instance, electric vehicles and hybrid vehicles can be powered wholly or in part by battery power. Despite the advantages of electric vehicles (e.g., pollution-free or low pollution), the batteries used to power the vehicle must be charged. During charging, the batteries can become very hot, and it is necessary to provide adequate heat exchange to remove heat from the batteries. Thus, tubes can be used to transport cooling fluids or compressed air to cool the battery. Tubing used in vehicles often have complicated angled geometry given the need to locate these tubes on or around different components within the vehicle.

To form tubes with complicated geometries, the tube is heated and cooled around a tool or fixture to provide a desired geometry. Known methods for tube shaping include placing hard-tooled metal components such as coil springs or soft flexible mandrels within the tube to prevent collapse or kinking during the forming step. The tubing is then held into place with external tooling to form the desired shape; and then heated to set the tube material in the desired configuration around the metal tool. After cooling the final formed tube, the hard-tooled metal component/or flexible mandrel is then removed from the tube. Such methods, however, are expensive and time consuming given that multiple hard-tooled components with varying geometries must be machined and placed within the tube.

As such, a need currently exists for improved tools and methods that can be used to form geometries in tubes.

### BRIEF SUMMARY

In accordance with one embodiment of the present disclosure, a mandrel for the manufacture of a tube is provided. The mandrel includes one or more discs spaced apart from each other; one or more guide wires coupled to one or more of the discs; and one or more control wires coupled to one or more of the discs. Articulation of one or more of the control wires induces a shape change in the tube. Methods for manufacturing a tube are also provided.

In accordance with one embodiment of the present disclosure, a method for manufacturing a tube is provided. The method includes disposing a mandrel in the tube. The mandrel includes one or more discs spaced apart from each other; one or more guide wires coupled to one or more of the discs; and one or more control wires coupled to one or more of the discs. The method includes articulating one or more control wires to induce a shape change in the tube and heating the tube to a first temperature with the mandrel disposed therein. The method also includes cooling the tube to a second temperature and removing the mandrel from the tube.

Other features and aspects of the present disclosure are set forth in greater detail below.

### BRIEF DESCRIPTION OF THE FIGURES

A full and enabling disclosure of the present disclosure, including the best mode thereof to one skilled in the art, is set forth more particularly in the remainder of the specification, including reference to the accompanying figures, in which:

FIG. 1 is a cross-sectional view of a mandrel according to example embodiments of the present disclosure;

FIG. 2 is a cross-sectional view of a mandrel according to example embodiments of the present disclosure;

FIG. 3 is a cross-sectional view of a mandrel according to example embodiments of the present disclosure;

FIG. 4 is a cross-sectional view of a mandrel according to example embodiments of the present disclosure;

FIG. 5 is a cross-sectional view of a mandrel according to example embodiments of the present disclosure;

FIG. 6 is a cross-sectional view of a mandrel according to example embodiments of the present disclosure;

FIG. 7 is a cross-sectional view of a mandrel according to example embodiments of the present disclosure;

FIG. 8 is a cross-sectional view of a mandrel according to example embodiments of the present disclosure;

FIG. 9 is a cross-sectional view of a mandrel according to example embodiments of the present disclosure;

FIG. 10 is a flow chart of a method of forming a tube according to example embodiments of the present disclosure;

FIG. 11 is a cross-sectional view of inserting a mandrel in a tube according to example embodiments of the present disclosure;

FIG. 12 is a cross-sectional view of shaping a tube using a mandrel according to example embodiments of the present disclosure;

FIG. 13 depicts an external fixture disposed on a tube according to example embodiments of the present disclosure;

FIG. 14 is a cross-sectional view of heating a tube according to example embodiments of the present disclosure;

FIG. 15 is a cross-sectional view of cooling a tube according to example embodiments of the present disclosure; and

FIG. 16 is a cross-sectional view of removing a mandrel from a tube according to example embodiments of the present disclosure.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a mandrel that can be used to form a tube. The mandrel includes one or more discs spaced apart from each other and one or more guide wires coupled to one or more of the discs. A control wire is also coupled to one or more of the discs. When the mandrel is inserted into a tube, articulation of the control wires induces a shape change in the mandrel resulting in bending of the tube. For instance, an angle with a desired bend radius can be formed in the tube by articulating the discs with the controls wire according to the present disclosure. Once shaped, the tube can be further processed (e.g., cured or set) to form a shaped tube. In embodiments, the guide wire includes a first guide wire running through the center of each disc and at least a first control wire disposed in a peripheral portion of one or more of the discs.

The present disclosure also provides a method for forming a tube. The method includes disposing a mandrel into the tube. The mandrel includes one or more discs spaced apart from each other, one or more guide wires, and one or more control wires coupled to one or more of the discs. Once inserted, the method includes articulating one or more of the control wires to induce a shape change in the mandrel forming an angle in the tube. The tube is then heated and cooled to set the angle of the tube. The mandrel can then be removed from the tube. The tube can be formed from a variety of materials including thermoplastic, elastomers, thermosets, thermoplastic vulcanizates, and combinations thereof.

The present inventors have discovered that the tube mandrel of the present disclosure can be utilized in a variety of configurations in different tube materials in order to induce desired shapes or angles. Advantageously, the mandrel of the present disclosure can be manipulated into a variety of shapes and angles and can be reused in multiple tubes during multiple cycles. For instance, a variety of different bend angles can be achieved by the disclosed mandrel. Further, once removed from a tube, the mandrel can then be inserted into another tube and articulated to provide a different bend angle. Thus, the mandrel of the present disclosure can be re-used numerous times and can provide different bending angles.

Additionally, given the number of machined tools, often times large batches of tubes are shaped or formed in an oven. Often, a large size heating oven is required. Such a large batching of tubes requires an oven with substantial footprint and also requires long processing times. However, use of the present mandrels to form tubes allows for heating in a smaller oven, thus reducing equipment space. Further, utilization of the disclosed mandrel and process yields a reduced processing time, which improves production efficiency.

Additionally, the inventors have discovered that the disclosed mandrel can be used to shape tubes formed from materials such as thermoplastic elastomers (TPEs), including thermoplastic vulcanizates (TPV). Shaping of TPV materials can be complicated given that this material often exhibits significant spring back and or deformation during or after processing. However, the present methods for shaping tubes allow for the bend angle to be adjusted to account for spring back of tube material and prevents surface deformations on the TPV tubes. TPV tubes formed according to the present methods retain the desired shape while having reduced deformations.

Various embodiments of the present disclosure will now be described in more detail.

### I. Mandrel

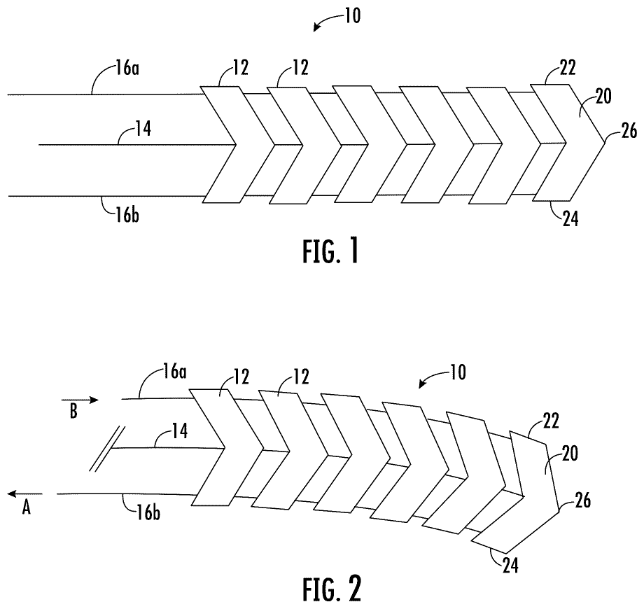

FIGS. 1-2 depict mandrels according to various embodiments of the present disclosure. Referring to FIG. 1, a mandrel 10 is shown that includes one or more discs 12, a guide wire 14, and one or more control wires 16. The discs 12 can include a plurality of discs 12 that are spaced apart from each other along the length of the guide wire 14. The distance between each of the discs 12 on the guide wire 14 can be altered according to desired preferences. For instance, in embodiments, the discs 12 are disposed equidistance away from each other along the length of the guide wire 14. In other embodiments, however, the discs 12 can be spaced in varying distances from each adjacent disc 12. In other embodiments, the discs 12 can include a single disc.

A guide wire 14 is disposed through the discs 12 and can be used to guide the mandrel 10 into a tube. In embodiments, the guide wire 14 is generally disposed through a center axis of the discs 12. However, the guide wire 14 can also be located in various locations of the discs 12. For instance, the guide wire 14 can be disposed a peripheral portion of the discs 12. Further, while only one guide wire 14 is shown, the disclosure is not so limited and one or more guide wires 14, such as at least two guide wires, such as at least three guide wires or even a plurality of guide wires can be utilized in accordance with the present disclosure.

One or more control wires 16 are disposed through the discs 12. As shown, a first control wire 16a is disposed through a peripheral portion of the discs 12 and a second control wire 16b is disposed through a peripheral portion of the discs that is located opposite from the first control wire 16a. Additional control wires 16 can be placed in a variety of locations throughout the discs 12. For instance, the mandrel 10 can include at least three control wires, such as at least four control wires, such as at least five control wires, such as a plurality of control wires. The number of control wires 16 can be selected based on the desired shape for the tube. For instance, a plurality of control wires 16 can be disposed from the center of the discs 12 extending to the periphery of the discs 12 and can be articulated to induce an angle within the mandrel 10. (Not shown). In other embodiments, the one or more control wires 16 may not be disposed through all the discs 12. Various embodiments and placements of control wires 16 are within the technical scope of this disclosure without departing from the technical effect.

The guide wire 14 and control wire 16 can be formed from any suitable materials. For instance, the guide wire 14 can be formed from a material that is strong enough to facilitate insertion of the mandrel 10 and discs 12 through a tube to place the mandrel 10 in a desired position within the tube. The control wires 16 can be formed of a material that is strong enough to induce shape change in the discs 12 when the control wires 16 are articulated (e.g., pulled). In embodiments, the guide wire 14 and/or control wires 16 are formed from a plastic material, a metal material, or combinations thereof. The plastic material can include thermoplastic materials including polyolefins, such as polyethylene or polypropylene. The plastic material can include plastics having high tensile strength, such as those having tensile strengths of greater than 50 MPa. Suitable metal materials can include elemental metals, metal alloys (e.g., stainless steel), and combinations thereof. In embodiments, the guide wire 14 and/or control wires 16 can be braided stainless steel. The guide wire 14 and/or control wires 16 can also include one or more coatings as desired. (Not shown). For instance, to decrease friction along the length of the guide wire 14 and/or control wires 16, the guide wire 14 and/or control wire 16 can be coated with a polymer material. In other embodiments, the guide wire 14, control wires 16, and/or discs can be coated with a lubricant to facilitate insertion of the mandrel 10 into a tube.

As depicted in FIG. 2, articulation of the control wires 16 causes the discs 12 to change shape or assume different positions within a tube, thus inducing a shape change within the tube. For instance, the second guide wire 16b is articulated in a direction indicated by arrow A and the first guide wire 16a can be articulated in a direction indicated by arrow B. In such an embodiment, a shape change is induced in the discs 12 and the resulting mandrel 10. For instance, a desired angle or bend radius can be induced in a tube via articulation of the control wires 16. Changing the placement of the discs 12 and/or the shape of the mandrel 10 can induce a bend or shape change in a tube, when the mandrel is inserted therein.

The discs 12 can be formed from a variety of materials, including flexible materials, such as thermoplastics, thermosets, elastomers, and other polymeric materials. In certain embodiments, the discs 12 can be formed from silicone. In another embodiment, the discs 12 can be formed from a low friction material, including low friction thermoplastic resins. Suitable thermoplastic resins can include polyolefin resins, such as polypropylene and/or polyethylene. In embodiments, the polyethylene includes an ultra-high molecular weight polyethylene (UHMWPE). The UHMWPE is a polyethylene polymer that comprises primarily ethylene-derived units. In some embodiments, the UHMWPE is a homopolymer of ethylene. In other embodiments, the UHMWPE is a copolymer of ethylene and an a-olefin such as 1-butene, 1-pentene, 1-hexene, 1-octene, 1-decene, 1-dodecene, 4-methyl-1-pentene, or 3-methyl-1-pentene.

The UHMWPE preferably has a weight average molecular weight of greater than 1,500,000 g/mol, or greater than 1,750,000 g/mol, or greater than 1,850,000 g/mol, or greater than 1,900,000 g/mol.

The UHMWPE may have a density greater than 0.91 g/mol, or greater than 0.92 g/cc, or greater than 0.93 g/cc. In some embodiments, the UHMWPE has a density of from 0.91 to 0.96 g/cc, or from 0.92 to 0.95 g/cc.

The UHMWPE may have a bulk specific gravity (ASTM D1895) of greater than 0.3 g/cc, or greater than 0.32 g/cc, or greater than 0.35 g/cc, or greater than 0.0.37 g/cc.

The UHMWPE may have a Shore D hardness of greater than 50, or greater than 55, or greater than 57, or greater than 60 (ASTM D2240). The UHMWPE may have a Shore D hardness of less than 100, or less than 90, or less than 80, or less than 75.

The UHMWPE may have a melting point (ASTM D3418) of greater than 100 C, or greater than 110° C., or greater than 115° C., or greater than 120° C., or greater than 125° C., or greater than 130° C. The UHMWPE may have a melting point of less than 200° C., or less than 190° C., or less than 180° C., or less than 170° C., or less than 160° C., or less than 150° C., or less than 140° C.

In embodiments, the discs 12 are formed from materials having a higher melting point as compared to certain or all of the materials used to form the tube. For instance, the discs 12 can be formed from a thermoplastic material and the tube can also be formed entirely from a thermoplastic material or can include a thermoplastic component. In such embodiments, the thermoplastic material used to form the discs 12 has a higher melting temperature as compared to the thermoplastic material(s) present in the tube.

In embodiments, the discs 12 are formed from a polyoxymethylene polymer. The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.1 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

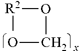

in which x is 0 or 1 and R² is a C₂-C₄-alkylene group which, if appropriate, has one or more substituents which are C₁-C₄-akyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers. It is particularly advantageous to use copolymers composed of from 99.5 to 95 mol. % of trioxane and of from 0.5 to 5 mol. %, such as from 0.5 to 4 mol. %, of one of the above-mentioned comonomers.

In one particular aspect of the present disclosure, the polyoxymethylene copolymer incorporated into the powder composition contains a relatively low amount of comonomer. For example, the polyoxymethylene copolymer can contain a comonomer, such as dioxolane, in an amount less than about 5% by weight, such as in an amount less than about 2% by weight, such as in an amount less than about 1.5% by weight, such as in an amount less than about 1% by weight, such as in an amount less than about 0.75% by weight, such as in an amount less than about 0.7% by weight. The comonomer content is generally greater than about 0.3% by weight, such as greater than about 0.5% by weight.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

The polyoxymethylene polymer incorporated into the polymer composition can have various different terminal groups or end groups depending upon the particular application and the other components contained in the composition. In one aspect, the polyoxymethylene polymer is relatively thermally stable. For instance, the polyoxymethylene polymer can contain hemiformal groups in an amount less than about 2 mol %, such as in an amount less than about 1.5 mol %, such as in an amount less than about 1 mol %, such as in an amount less than about 0.8 mol %, such as in an amount less than about 0.6 mol %.

The amount of hydroxyl end groups on the polyoxymethylene polymer can depend on whether a polyisocyanate coupling agent is present in the composition. When a polyisocyanate coupling agent is not present, for instance, the polyoxymethylene polymer can have a terminal hydroxyl group content of less than about 10 mmol/kg, such as less than about 8 mmol/kg, such as less than about 6 mmol/kg, such as less than about 4 mmol/kg.

Alternatively, the polyoxymethylene polymer can contain greater amounts of terminal hydroxyl groups. In one embodiment, the polyoxymethylene polymer has a content of terminal hydroxyl groups of at least 15 mmol/kg, such as at least 18 mmol/kg, such as at least 20 mmol/kg, such as greater than about 25 mmol/kg, such as greater than about 30 mmol/kg, such as greater than about 40 mmol/kg, such as greater than about 50 mmol/kg. The terminal hydroxyl content is generally less than about 300 mmol/kg, such as less than about 200 mmol/kg, such as less than about 100 mmol/kg. In one embodiment, the terminal hydroxyl group content ranges from 18 to 50 mmol/kg. The quantification of the hydroxyl group content in the polyoxymethylene polymer may be conducted by the method described in JP-A-2001-11143.

In addition to the terminal hydroxyl groups, the polyoxymethylene polymer may also have other terminal groups usual for these polymers. Examples of these are alkoxy groups, formate groups, acetate groups or aldehyde groups. In one aspect, the polyoxymethylene polymer can also contain terminal-NH₂ groups. According to one embodiment, the polyoxymethylene is a copolymer which comprises at least 50 mol-%, such as at least 75 mol-%, such as at least 90 mol-% and such as even at least 95 mol-% of —CH₂O-repeat units.

The polyoxymethylene polymer can have any suitable molecular weight. The molecular weight of the polymer, for instance, can be from about 4,000 grams per mole to about 100,000 g/mol. The polyoxymethylene polymer, for instance, can have a molecular weight of greater than about 10,000 g/mol, such as greater than about 15,000 g/mol, such as greater than about 20,000 g/mol, such as greater than about 30,000 g/mol, such as greater than about 40,000 g/mol, and generally less than about 90,000 g/mol.

The polyoxymethylene polymer utilized herein can generally have a melt flow index (MFI) ranging from about 0.1 to about 200 g/10 min. Melt flow is determined according to ISO 1133 at 190° C. and 2.16 kg. In one aspect, however, the polyoxymethylene polymer has a relatively low melt flow index. The lower melt flow index has been found to result in a polymer composition having a larger operating window when used in rotational molding processes. In addition, the lower melt flow rate can lead to better physical properties. For instance, the polyoxymethylene polymer can have a melt flow rate of less than about 8 g/10 min, such as less than about 5 g/10 min, such as less than about 4 g/10 min, such as less than about 3 g/10 min, such as less than about 2 g/10 min, such as less than about 1 g/10 min, and generally greater than about 0.5 g/10 min.

In embodiments, the discs 12 are formed from polyamides. In one embodiment, for instance, polyamides may be employed that generally have a CO—NH linkage in the main chain and are obtained by condensation of an aliphatic diamine and an aliphatic dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Aliphatic dicarboxylic acids may include, for instance, adipic acid, sebacic acid, etc. Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable.

It should be understood that it is also possible to include aromatic monomer units in the polyamide such that it is considered aromatic (contains only aromatic monomer units are both aliphatic and aromatic monomer units). Examples of aromatic dicarboxylic acids may include, for instance, terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc. Particularly suitable aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephlhalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene lerephthalamide/dodecamelhylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

The polyamide may crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2020 (glass transition) and 11357-3:2018 (melting).

For instance, if the primary matrix polymer of the polymer composition is a polyamide, the carrier polymer can also be a polyamide, such as nylon-6 or nylon-6,6.

The discs 12 can also be formed from metals, metal alloys, and/or combinations thereof. For instance, discs can be formed from titanium and alloys thereof, iron and allows thereof, aluminum and alloys thereof, titanium and alloys thereof. In embodiments, the metal material can include steel and alloys thereof.

The discs 12 can encompass a variety of shapes. For instance, the discs can be circular, ovular, etc. In embodiments, as shown, the disc 12 includes a disc body 20 having a first end 22 and a second end 24. The first end 22 and second end 24 are disposed at an angle from the center 26 of the disc 12. As such, the discs 12 can have an angled shape. In embodiments, the discs 12 can include a variety of shapes disposed adjacent to each other along the guide wire 14. (Not shown). Notably, while the term “disc” is used, such a term is not limited to only discs having a circular cross-section. Indeed, the term “disc” refers to a member having a disc body that can be a variety of shapes and configurations.

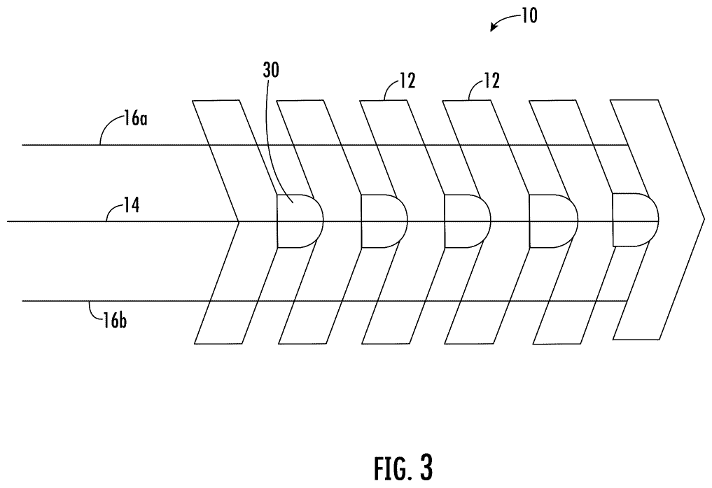

Referring to FIG. 3, the discs 12 can be coupled via one or more joints 30. For instance, one or more joints 30 can be disposed between adjacent discs 12. The joints 30 can include ball joints and are configured to allow for multi-directional bending and flexing of the discs 12 to form the desired shape for the mandrel 10. Utilization of joints 30 can provide a more flexible mandrel 10 that can be shaped into smaller angles or can even be formed into U-shaped patterns, S-patterns, and the like. The joints 30 can be comprised of the same or different material as the discs 12. In embodiments, the joints 30 are disposed about the center of the discs 12. As shown, a guide wire 14 is also disposed through the center of the discs 12 and through the joints 30. A first control wire 16a is disposed through a peripheral portion of the discs 12 and a second control wire 16b is disposed through a second peripheral portion of the discs 12 that is opposite from the first control wire 16a.

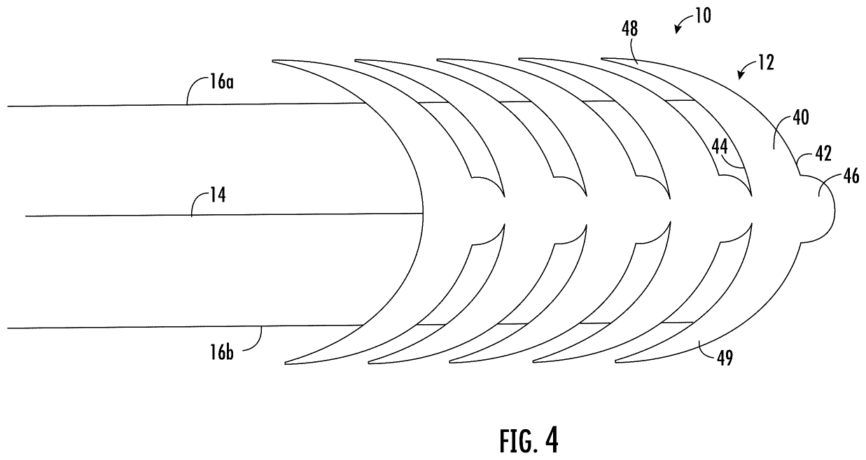

FIG. 4 depicts another example embodiment of a mandrel 10 having discs 12 that include a curved disc body 40. The curved disc body 40 has a first side 42 and a second side 44. The first side 42 includes a protrusion 46 extending therefrom. The protrusion 46 can be disposed in a center portion of the curved disc body 40. In embodiments, the protrusion 46 is round, however, the protrusion 46 can encompass a variety of other shapes, such as ovals, triangles, etc. The curved disc body 40 has a first tapered arm 48 and a second tapered arm 49. The first control wire 16a is disposed through the first tapered arm 48 and the second control wire 16b is disposed through the second tapered arm 39. A guide wire 14 is disposed through the center of the discs 12 and can run through each of the protrusions 36 located on the discs 12. When the control wires 16a, 16b are articulated to shape the mandrel 10, certain of the tapered arms 38, 39 can lay flat against the tapered arms 38,39 of the adjacent disc 12, thereby creating a smooth external surface for the mandrel 10. Such a mandrel 10 can be used for forming a tube where a smoother internal surface of the resulting tube is desired.

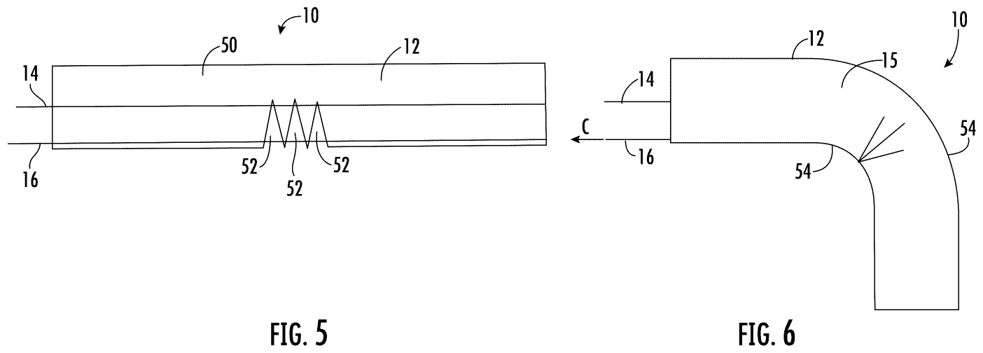

In FIG. 5, another embodiment of a mandrel 10 is depicted. In this embodiment, the mandrel 10 includes a single disc 12 having a disc body 50 with one or more cavities 52 disposed therein. As shown, the disc body 50 includes a plurality of cavities 52, however, any number of cavities 52 can be utilized to shape the disc body 50 into the desired shape. A guide wire 14 is disposed through the center of the disc body 50 and a control wire 16 is disposed through a peripheral portion of the disc body 50. While only one control wire 16 is illustrated, is it to be understood that any number of control wires 16 can be included without departing from the scope of the disclosure. The cavities 52 can be any suitable shape, include triangular, ovular, circular, rectangular, etc. Now referring to FIG. 6, to shape the mandrel 10, the control wire 16 is articulated in the direction of arrow C, and the cavities 52 from FIG. 5 are closed. The disc body 50 forms a solid disc body 50 having an angle disposed therein. The disc body 50 as shown in FIG. 6 includes an outer surface 54 that is a solid external surface. Such a mandrel 10 can be used for forming a tube where a smoother internal surface of the resulting tube is desired.

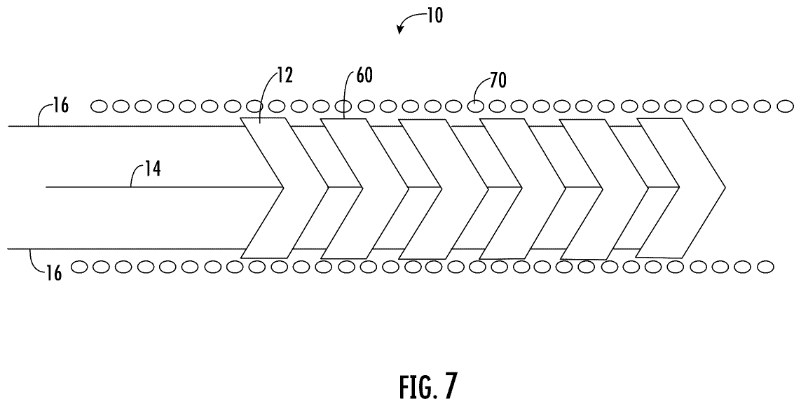

Now referring to FIG. 7, a mandrel 10 is depicted having a covering 70 disposed adjacent to one or more external surface 72 of the discs 12. In such an embodiment, the covering 70 can provide a smoother external surface for the mandrel 10 when it is articulated to its desired shape. For instance, the covering 70 can cover the gaps between adjacent discs 12, thereby providing a smoother external surface. Similar to other embodiments disclosed herein, use of a mandrel 10 having the covering 70 can be useful for forming a tube where a smoother internal surface of the resulting tube is desired.

The covering 70 can be formed from any suitable materials. For instance, in one embodiment the covering can be a coiled spring. The coiled spring can be formed from a plastic and/or metal material. The spring can be placed around the discs 12, control wires 16, and/or guide wires 14. In other embodiments, the covering 70 can be formed from a polymer material. The polymer material can include a thermoplastic, thermoset, or elastomer material. The covering 70 can include a cylindrical sheath into which the mandrel 10 can be inserted.

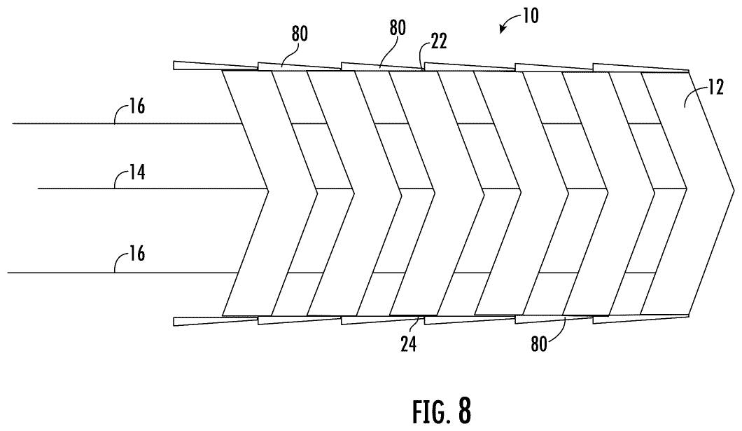

Referring to FIG. 8, in other embodiments, one or more skirting panels 80 can be disposed about the first end 22 or the second end 24 of the discs 12. As shown, skirting panels 80 can be attached to the first ends 22 of each of the discs 12. However, in other embodiments, not all the discs 12 have a skirting panel 80 coupled thereto. Further, in embodiments the skirting panels 80 can be coupled to the first ends 22 of the discs 12 and no skirting panels are coupled to the second ends 24 of the discs 12. In another embodiment, the skirting panels 80 can be coupled to the second ends 24 of the discs 12 but not the first ends 22 of the discs 12. The skirting panels 80 can be formed from the same or different material as the discs 12. For instance, in embodiments the skirting panels 80 are formed from a flexible polymer material. Similar to other embodiments disclosed herein, use of a mandrel 10 having the skirting panels 80 can facilitate formation of a tube where a smoother internal surface of the resulting tube is desired.

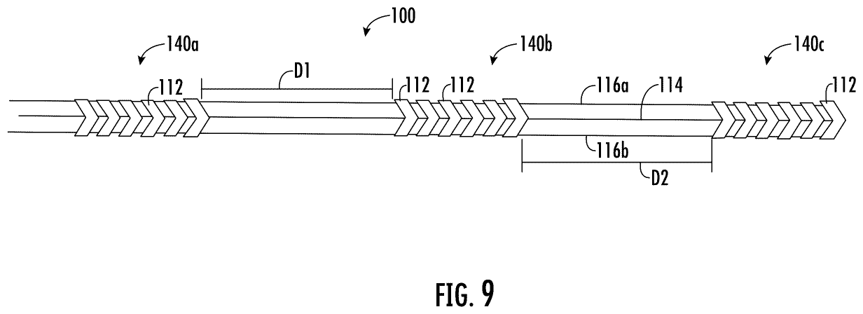

FIG. 9 illustrates a mandrel 100 having multiple groupings 140 of discs 112 disposed thereon. For instance, as shown the mandrel 100 includes a first grouping 140a and a second grouping 140b disposed a distance (D1) apart from each other along the length of the guide wire 114. The first grouping 140a includes a plurality of discs 112 and the second grouping 120b includes a plurality of discs 112. A third grouping 140c is disposed a distance (D2) apart from the second grouping 140b. Distance (D1) and distance (D2) can be the same distance or can be different distances depending on the desired shape for the tube. Such a mandrel 100 is a multi-stage mandrel 100 that can be used to provide a variety of shapes in a tube at various locations along the tube. For instance, control wires 116a, 116b are disposed through one or more of the discs 112 located in each grouping 140a, 140b, 140c. The control wires 116a, 116b can be articulated to induce a variety of shapes in the discs 112. A guide wire 114 is disposed through one or more of the discs 112 in each grouping 140a, 140b, 140c.

### II. Tube Material

Notably, the mandrels as disclosed herein are to be inserted into a tube and used to bend or shape the tube. Suitable tube materials include thermoplastic polymers, elastomers, thermoset materials, and combinations thereof.

### A. Thermoplastic Materials

The tubes utilized herein can be formed from one or more thermoplastic resins. In one embodiment, one thermoplastic resin may be utilized as the thermoplastic resin. In other embodiments, the thermoplastic resin may include a mixture of thermoplastic resins. For instance, more than one thermoplastic resin, such as two or three thermoplastic resins, may be utilized in the thermoplastic vulcanizate. Furthermore, the thermoplastic resin may be a homopolymer or a copolymer. In one embodiment, the thermoplastic resin may be a homopolymer. In another embodiment, the thermoplastic resin may be a copolymer.

In general, any thermoplastic resin suitable for use in the manufacture of a tube (e.g., hose) can be employed as the thermoplastic resin. For instance, the thermoplastic resin may include a polyolefin, a polyimide, a polyester, a polyamide, poly(phenylene ether), a polycarbonate, a styrene-acrylonitrile copolymer, polyethylene terephthalate, polybutylene terephthalate, polystyrene, polystyrene derivatives, polyphenylene oxide, polyoxymethylene, fluorine-containing thermoplastic resins, or a mixture thereof.

In one embodiment, the thermoplastic resin may include at least a polyolefin. The polyolefin can be formed by polymerizing one or more alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another alpha-olefin such as 1-butene, 1-hexene, 1-octene, 2-methyl-1-propene, 3-methyl-1-pentene, 4-methyl-1-pentene, 5-methyl-1-hexene or mixtures thereof may be also utilized in accordance with the present disclosure. In one embodiment, when the primary monomer is ethylene, the copolymer may be propylene or another C₄-C₈ alpha-olefin monomer. In one embodiment, the comonomer may be propylene. In another embodiment, the comonomer may be a C₄-C₈ alpha-olefin monomer. When the primary monomer is propylene, the copolymer may be ethylene or another C₄-C₈ alpha-olefin monomer. In one embodiment, the comonomer may be ethylene. In another embodiment, the comonomer may be a C₄-C₈ alpha-olefin monomer.

Other suitable polyolefin copolymers may include copolymers of olefins with styrene such as styrene-ethylene copolymer or polymers of olefins with α,β-unsaturated acids, α,β-unsaturated esters such as polyethylene-acrylate copolymers. Non-olefin thermoplastic resins may include polymers and copolymers of styrene, α,β-unsaturated acids, α,β-unsaturated esters, and mixtures thereof. For example, polystyrene, polyacrylate, and polymethacrylate may be used.

When the thermoplastic resin includes a polyolefin copolymer formed of ethylene or propylene as the primary monomer, the corresponding comonomer may be present in an amount of 0.1 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more. The comonomer may be present in an amount of 40 wt. % or less, such as 30 wt. % or less, such as 25 wt. % or less, such as 20 wt. % or less, such as 15 wt. % or less, such as 10 wt. % or less, such as 8 wt. % or less, such as 6 wt. % or less, such as 5 wt. % or less. Similarly, the corresponding comonomer may be present in an amount of 0.1 mol. % or more, such as 0.5 mol. % or more, such as 1 mol. % or more, such as 2 mol. % or more, such as 5 mol. % or more, such as 10 mol. % or more, such as 15 mol. % or more, such as 20 mol. % or more. The comonomer may be present in an amount of 40 mol. % or less, such as 30 mol. % or less, such as 25 mol. % or less, such as 20 mol. % or less, such as 15 mol. % or less, such as 10 mol. % or less, such as 8 mol. % or less, such as 6 mol. % or less, such as 5 mol. % or less.

In one embodiment, the polyolefin may be an ethylene polymer, a propylene polymer, or a mixture thereof. For instance, the ethylene polymer may be a polyethylene homopolymer in one embodiment. In another embodiment, the ethylene polymer may be a polyethylene copolymer. The propylene polymer may be a polypropylene homopolymer in one embodiment. In another embodiment, the propylene polymer may be a polypropylene copolymer. Furthermore, the polypropylene polymer may be isotactic or syndiotactic polypropylene. For instance, the polypropylene polymer may be isotactic polypropylene in one embodiment. In another embodiment, the polypropylene polymer may be syndiotactic polypropylene.

These homopolymers and copolymers may be synthesized using any polymerization technique known in the art such as, but not limited to, the Phillips catalyzed reactions, conventional Ziegler-Natta type polymerizations, and metallocene catalysis including, but not limited to, metallocene-alumoxane and metallocene-ionic activator catalysis. Suitable catalyst systems thus include chiral metallocene catalyst systems, see, e.g., U.S. Pat. No. 5,441,920, and transition metal-centered, heteroaryl ligand catalyst systems, see, e.g., U.S. Pat. No. 6,960,635.

In one embodiment, the thermoplastic resin may also include a functionalized thermoplastic resin. The functionalized thermoplastic resin in one embodiment may be present as the primary thermoplastic resin. In another embodiment, the functionalized thermoplastic resin may be present as a secondary thermoplastic resin, for instance in an amount less than another thermoplastic resin.

The functionalized thermoplastic resin may include a polymer including at least one functional group. The functional group, which may also be referred to as a functional substituent or functional moiety, includes a hetero atom. In one or more embodiments, the functional group includes a polar group. Examples of polar groups include hydroxy, carbonyl, ether, halide, amine, imine, nitrile, silyl, epoxide, or isocyanate groups. Exemplary groups containing a carbonyl moiety include carboxylic acid, anhydride, ketone, acid halide, ester, amide, or imide groups, and derivatives thereof. In one embodiment, the functional group includes a succinic anhydride group, or the corresponding acid, which may derive from a reaction (e.g., polymerization or grafting reaction) with maleic anhydride, or a β-alkyl substituted propanoic acid group or derivative thereof.

In general, the thermoplastic resin can include a solid, generally high molecular weight polymeric material. The thermoplastic resin may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mw may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. Furthermore, the thermoplastic resin may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mn may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. In general, the molecular weight may be characterized by GPC (gel permeation chromatography) using polystyrene standards.

The thermoplastic resin may be a crystalline polymer in one embodiment or a semi-crystalline polymer in another embodiment. For instance, the crystallinity may be at least 25%, such as at least 35%, such as at least 45%, such as at least 55%, such as at least 65%, such as at least 70% by weight. The crystallinity may be determined by differential scanning calorimetry. For instance, crystallinity may be determined by dividing the heat of fusion of a sample by the heat of fusion of a 100% crystalline polymer.

The thermoplastic resin may also have a particular glass transition temperature (“Tg”). For instance, the glass transition temperature may be relatively high. In this regard, the Tg may be about −120° C. or more, such as −110° C. or more, such as −100° C. or more, such as −90° C. or more, such as −70° C. or more, such as −50° C. or more, such as −30° C. or more, such as −25° C. or more, such as −20° C. or more, such as −15° C. or more, such as −10° C. or more, such as −5° C. or more, such as 0° C. or more, such as 5° C. or more, such as 10° C. or more, such as 20° C. or more, such as 30° C. or more, such as 50° C. or more, such as 80° C. or more, such as 100° C. or more, such as 120° C. or more, such as 140° C. or more, such as 160° C. or more, such as 180° C. or more, such as 200° C. or more. The Tg may be about 300° C. or less, such as 260° C. or less, such as 220° C. or less, such as 180° C. or less, such as 140° C. or less, such as 100° C. or less, such as 80° C. or less, such as 60° C. or less, such as 40° C. or less, such as 30° C. or less, such as 20° C. or less, such as 10° C. or less, such as 5° C. or less, such as 0° C. or less, such as −5° C. or less.

In addition, the thermoplastic resin may have a particular melt temperature (“Tm”). For instance, the melt temperature of the thermoplastic resin may be relatively high. In this regard, the Tm may be about 100° C. or more, such as 120° C. or more, such as 140° C. or more, such as 150° C. or more, such as 160° C. or more, such as 170° C. or more, such as 180° C. or more, such as 190° C. or more, such as 200° C. or more, such as 240° C. or more, such as 280° C. or more. The Tm may be about 400° C. or less, such as 360° C. or less, such as 320° C. or less, such as 300° C. or less, such as 280° C. or less, such as 250° C. or less, such as 220° C. or less, such as 200° C. or less, such as 180° C. or less, such as 160° C. or less.

The thermoplastic resin may also be characterized as having a particular heat of fusion. For instance, the heat of fusion may be about 0.1 J/g or more, such as about 1 J/g or more, such as about 2 J/g or more, such as about 5 J/g or more, such as about 10 J/g or more, such as about 10 J/g or more, such as about 30 J/g or more, such as 40 J/g or more, such as 50 J/g or more, such as 60 J/g or more, such as 70 J/g or more, such as 100 J/g or more, such as 120 J/g or more, such as 140 J/g or more, such as 160 J/g or more, such as 180 J/g or more, such as 200 J/g or more. The heat of fusion may be about 300 J/g or less, such as about 260 J/g or less, such as about 240 J/g or less, such as about 200 J/g or less, such as about 180 J/g or less, such as about 150 J/g or less, such as about 120 J/g or less, such as about 100 J/g or less, such as about 80 J/g or less, such as about 60 J/g or less, such as about 50 J/g or less, such as about 40 J/g or less, such as about 30 J/g or less, such as about 20 J/g or less.

The thermoplastic resin may have a melt flow rate of up to 400 g/10 min. In general, the thermoplastic resin may have better properties where the melt flow rate is less than about 30 g/10 min., preferably less than 10 g/10 min, such as less than about 2 g/10 min, such as less than about 1 g/10 min, such as less than about 0.8 g/10 min. In general, the melt flow rate may be 0.1 g/10 min or more, such as 0.2 g/10 min or more, such as 0.3 g/10 min or more, such as 0.4 g/10 min or more, such as 0.5 g/10 min or more. Melt flow rate is a measure of how easily a polymer flows under standard pressure and is measured by using ASTM D-1238 at 190° C. and 2.16 kg load.

Suitable thermoplastic materials for use as tube material include for instance, a polyolefin, a polyimide, a polyester, a polyamide, poly(phenylene ether), a polycarbonate, a styrene-acrylonitrile copolymer, polyethylene terephthalate, polybutylene terephthalate, polystyrene, polystyrene derivatives, polyphenylene oxide, polyoxymethylene, fluorine-containing thermoplastic resins, polyvinyl chloride, or a mixture thereof. The exact choice of the polymer system will depend upon a variety of factors, such as the nature of other fillers included within the composition, the manner in which the composition is formed and/or processed, and the specific requirements of the intended tube. The thermoplastic polymer can include a mixture of thermoplastic resins and can include homopolymers, copolymers, or combinations thereof.

### B. Elastomers

As indicated above, the tube can be formed from an elastomer. In general, any elastomer suitable for use in the manufacture of tubes (e.g., hoses) can be utilized in accordance with the present disclosure. In one embodiment, one elastomer may be utilized as the elastomer. In other embodiments, the elastomer may include a mixture of elastomers. For instance, more than one elastomer, such as two or three elastomers, may be utilized in the tube.

Any elastomer or mixture thereof that is capable of being vulcanized (that is crosslinked or cured) can be used as the elastomer (also referred to herein sometimes as the rubber). Reference to a rubber or elastomer may include mixtures of more than one. Useful elastomers typically contain a degree of unsaturation in their polymeric main chain. Some non-limiting examples of these rubbers include polyolefin copolymer elastomers, butyl rubber, natural rubber, styrene-butadiene copolymer rubber (e.g., styrene/ethylene-butadiene/styrene), butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlorohydrin terpolymer rubber, ethylene propylene diene monomer (EPDMP rubber, and polychloroprene.

Vulcanizable elastomers include polyolefin copolymer elastomers. These copolymers are made from one or more of ethylene and higher alpha-olefins, which may include, but are not limited to propylene, 1-butene, 1-hexene, 4-methyl-1 pentene, 1-octene, 1-decene, or combinations thereof, and may include one or more copolymerizable, multiply unsaturated comonomer, such as diolefins, or diene monomers. The alpha-olefins can be propylene, 1-hexene, 1-octene, or combinations thereof. These rubbers may lack substantial crystallinity and can be suitably amorphous copolymers.

The diene monomers may include, but are not limited to, 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; 5-vinyl-2-norbornene, divinyl benzene, and the like, or a combination thereof. The diene monomers can be 5-ethylidene-2-norbornene and/or 5-vinyl-2-norbornene. If the copolymer is prepared from ethylene, alpha-olefin, and diene monomers, the copolymer may be referred to as a terpolymer (EPDM rubber), or a tetrapolymer in the event that multiple alpha-olefins or dienes, or both, are used (EAODM rubber).

In one embodiment, the polyolefin elastomer copolymer may include an ethylene acrylic copolymer (also referred to as an ethylene-acrylate copolymer). The ethylene acrylic copolymer comprises (i) copolymerized units of a monomer having the structure represented by formula (A):

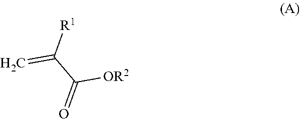

wherein R¹ is hydrogen or a C₁-C₁₂ alkyl and R² is a C₁-C₁₂ alkyl, a C₁-C₂₀ alkoxyalkyl, a C₁-C₁₂ cyanoalkyl, or a C₁-C₁₂ haloalkyl (e.g., fluoroalkyl or bromoalkyl) and (ii) copolymerized units of ethylene. The ethylene acrylic copolymer may also optionally comprise (iii) copolymerized units of an unsaturated carboxylic acid or an anhydride thereof.

The ethylene acrylic copolymer may be amorphous. The term “amorphous” generally refers to a copolymer that exhibits little or no crystalline structure at room temperature in the unstressed state. Alternatively, an amorphous material may have a heat of fusion of less than 4 J/g, as determined according to ASTM D3418-08

As indicated above, the ethylene acrylic copolymer comprises copolymerized units (i) of the monomer of formula (A). Such monomer may be an alkyl ester or alkoxyalkyl ester of propenoic acid. In this regard, the ethylene acrylic copolymer may comprise an alkyl ester or alkoxyalkyl ester of propenoic acid together with a cure site monomer and an ethylene monomer. Examples of suitable alkyl and alkoxyalkyl esters of propenoic acid include alkyl acrylates and alkoxyalkyl acrylates as well as monomers in which the propenoic acid is substituted with a C₁-C₁₂ alkyl group. Examples include an alkyl methacrylate, an alkyl ethacrylate, an alkyl propacrylate, an alkyl hexacrylate, an alkoxyalkyl methacrylate, an alkoxyalkyl ethacryate, an alkoxyalkyl propacrylate, an alkoxyalkyl hexacrylate, and any combination thereof.

The alkyl and alkoxyalkyl esters of propenoic acid and substituted propenoic acids can be C₁-C₁₂ alkyl esters of acrylic or methacrylic acid or C₁-C₂₀ alkoxyalkyl esters of acrylic or methacrylic acid. Examples include methyl acrylate, methyl methacrylate, ethyl acrylate, ethyl methacrylate, butyl acrylate, butyl methacrylate, 2-ethylhexyl acrylate, 2 methoxyethylacrylate, 2-ethoxyethylacrylate, 2-(n-propoxy)ethylacrylate, 2 (n-butoxy)ethylacrylate, 3-methoxypropylacrylate, 3-ethoxypropyl-acrylate, and mixtures thereof. The ester group can comprise branched or unbranched C₁-C₈ alkyl groups or unbranched C₁-C₄ alkyl groups. Specific examples include alkyl (meth)acrylate esters such as methyl acrylate, methyl methacrylate, ethyl acrylate, butyl acrylate, and mixtures thereof.

The polymerized units of the monomer of formula (A) can be present in an amount ranging from about 20% or more, such as about 30% or more, such as about 40% or more, such as about 45% or more, such as about 50% or more, to about 75% or less, such as about 70% or less, such as about 65% or less by weight of the ethylene acrylic copolymer. For example, polymerized units of the monomer of formula (A), such as a propenoic acid ester comonomer, can be present in an amount ranging from about 45% or from about 50% to about 70% by weight of the ethylene acrylic copolymer. In some examples, the concentration of polymerized units of the monomer of formula (A), such as a propenoic acid ester comonomer, can range from about 55% to about 70% by weight of the ethylene acrylic copolymer. Also, as generally understood, the polymerized units of the monomer of formula (A) may include a first monomer of formula (A) and a second monomer of (A) wherein the combination of the monomers is present in the aforementioned weight percentages.

In addition to comprising the polymerized units of a monomer of formula (A), the ethylene acrylic copolymer comprises copolymerized units of ethylene. The copolymerized units of ethylene can constitute the remainder of the weight % of the ethylene acrylic copolymer, after accounting for the copolymerized units of the monomer of formula (A) and any other monomers, such as the optional copolymerized units of the unsaturated carboxylic acid or an anhydride thereof. For example, the copolymerized units of ethylene can be present in an amount ranging from about 10% or more, such as about 15% or more, such as about 20% or more, such as about 25% or more, such as about 28% or more, such as about 30% or more, such as about 35% or more, such as about 40% or more to about 65% or less, such as about 60% or less, such as about 58% or less, such as about 55% or less, such as about 50% or less, such as about 45% or less, such as about 40% or less by weight of the ethylene acrylic copolymer. The copolymerized units of ethylene can constitute the balance of the weight percent being attributed to the copolymerized units of the monomer of formula (A) and if present, the copolymerized units of the unsaturated carboxylic acid or an anhydride thereof.

In addition to comprising the polymerized units of a monomer of formula (A) and the copolymerized units of ethylene, the ethylene acrylic copolymer may further comprise a copolymerized cure site monomer such as a carboxylic acid, an anhydride thereof, or any mixture of the acid and anhydride of the acid. Suitable unsaturated carboxylic acids include acrylic acid, methacrylic acid, 1,4-butenedioic acids, citraconic acid, monoalkyl esters of 1,4-butenedioic acids, and mixtures thereof. The 1,4-butenedioic acids may exist in cis- or trans-form or both (e.g., maleic acid or fumaric acid) prior to polymerization. Suitable cure site comonomers also include anhydrides of unsaturated carboxylic acids, such as maleic anhydride, citraconic anhydride, itaconic anhydride, and mixtures thereof. Cure site monomers can include maleic acid and any of its half acid esters (monoesters) or diesters, such as the methyl or ethyl half acid esters (e.g., monoethyl maleate); fumaric acid and any of its half acid esters or diesters, such as the methyl, ethyl or butyl half acid esters; and monoalkyl and monoarylalkyl esters of itaconic acid. The cure site monomer can be present in some examples in an amount ranging from about 0.5% or more, such as about 1% or more, such as about 1.5% or more, such as about 2% or more to about 10% or less, such as about 8% or less, such as about 6% or less, such as about 5% or less, such as about 4% or less, such as about 3% or less by weight of the ethylene acrylic copolymer, such as from about 2% to about 5% by weight, such as from about 2% to about 4% by weight of the ethylene acrylic copolymer.

The ethylene acrylic copolymer may consist essentially of or consist of the copolymerized units of the monomer of formula (A), the copolymerized units of ethylene, and the optional copolymerized units of an unsaturated carboxylic acid or an anhydride thereof. In another embodiment, the ethylene acrylic copolymer may consist essentially of or consist of the copolymerized units of the monomer of formula (A), the copolymerized units of ethylene, and the copolymerized units of an unsaturated carboxylic acid or an anhydride thereof. “Consist essentially of” in this context refers to an ethylene acrylic copolymer that does not materially diminish the elastomeric properties of the ethylene acrylic copolymer if the copolymer consisted solely of the copolymerized units.

One specific example of the ethylene acrylic copolymer includes a copolymer of (i) methyl acrylate, butyl acrylate, or any combination thereof, present in an amount ranging from about 50% to about 70% by weight of the ethylene acrylic copolymer; (ii) ethylene, which constitutes the remainder of the weight % of the ethylene acrylic copolymer; and (iii) a cure site monomer having carboxylic acid functionality, present in an amount ranging from about 2% to about 5% by weight of the ethylene acrylic copolymer (e.g., 2% to 4%).

Elastomers that are polyolefin elastomer copolymers can contain, unless specified otherwise herein, from about 15 to about 90 mole percent ethylene units deriving from ethylene monomer, from about 40 to about 85 mole percent, or from about 50 to about 80 mole percent ethylene units. The copolymer may contain from about 10 to about 85 mole percent, or from about 15 to about 50 mole percent, or from about 20 to about 40 mole percent, alpha-olefin units deriving from alpha-olefin monomers. The foregoing mole percentages are based upon the total moles of the mer units of the polymer. Where the copolymer contains diene units, the copolymers may contain from 0.1 to about 14 weight percent, from about 0.2 to about 13 weight percent, or from about 1 to about 12 weight percent units deriving from diene monomer. The weight percent diene units deriving from diene may be determined according to ASTM D-6047. In some occurrences, the copolymers contain less than 5.5 weight percent, such as less than 5.0 weight percent, such as less than 4.5 weight percent, such as less than 4.0 weight percent units deriving from diene monomer. In yet other cases, the copolymers contain greater than 6.0 weight percent, such as greater than 6.2 weight percent, such as greater than 6.5 weight percent, such as greater than 7.0 weight percent units, such as greater than 8.0 weight percent deriving from diene monomer.

The polyolefin elastomer copolymer may be obtained using polymerization techniques known in the art such as traditional solution or slurry polymerization processes. For instance, the catalyst employed to polymerize the ethylene, alpha-olefin, and diene monomers into elastomeric copolymers can include both traditional Ziegler-Natta type catalyst systems, especially tubes including titanium and vanadium compounds, as well as metallocene catalysts for Group 3-6 (titanium, zirconium, and hafnium) metallocene catalysts, particularly the bridged mono- or biscyclopentadienyl metallocene catalysts. Other catalyst systems such as Brookhart catalyst systems may also be employed.

In one embodiment, the elastomer may include a butyl rubber. For instance, the butyl rubber includes copolymers and terpolymers of isobutylene and at least one other comonomer. Useful comonomers include isoprene, divinyl aromatic monomers, alkyl substituted vinyl aromatic monomers, and mixtures thereof. Exemplary divinyl aromatic monomers include vinyl styrene. Exemplary alkyl substituted vinyl aromatic monomers include α-methyl styrene and paramethyl styrene. These copolymers and terpolymers may also be halogenated such as in the case of chlorinated and brominated butyl rubber. In one or more embodiments, these halogenated polymers may derive from monomers such as parabromomethylstyrene.

In one or more embodiments, the butyl rubber includes copolymers of isobutylene and isoprene, copolymers of isobutylene and paramethyl styrene, terpolymers of isobutylene, isoprene, and divinyl styrene, branched butyl rubber, and brominated copolymers of isobutene and paramethylstyrene (yielding copolymers with parabromomethylstyrenyl mer units). These copolymers and terpolymers may be halogenated. Furthermore, butyl rubbers may be prepared by polymerization, using techniques known in the art such as at a low temperature in the presence of a Friedel-Crafts catalyst.

In one embodiment, where the butyl rubber includes the isobutylene-isoprene copolymer, the copolymer may include from about 0.5 to about 30, or from about 0.8 to about 5, percent by weight isoprene based on the entire weight of the copolymer with the remainder being isobutylene.

In another embodiment, where the butyl rubber includes isobutylene-paramethyl styrene copolymer, the copolymer may include from about 0.5 to about 25, and from about 2 to about 20, percent by weight paramethyl styrene based on the entire weight of the copolymer with the remainder being isobutylene. In one embodiment, isobutylene-paramethyl styrene copolymers can be halogenated, such as with bromine, and these halogenated copolymers can contain from about 0 to about 10 percent by weight, or from about 0.3 to about 7 percent by weight halogenation.

In other embodiments, where the butyl rubber includes isobutylene-isoprene-divinyl styrene, the terpolymer may include from about 95 to about 99, or from about 96 to about 98.5, percent by weight isobutylene, and from about 0.5 to about 5, or from about 0.8 to about 2.5, percent by weight isoprene based on the entire weight of the terpolymer, with the balance being divinyl styrene.

In the case of halogenated butyl rubbers, the butyl rubber may include from about 0.1 to about 10, or from about 0.3 to about 7, or from about 0.5 to about 3 percent by weight halogen based upon the entire weight of the copolymer or terpolymer.

In one or more embodiments, the glass transition temperature (Tg) of the butyl rubber can be less than about −55° C., or less than about −58° C., or less than about −60° C., or less than about −63° C. Also, the Mooney viscosity (ML₁₊₈@125° C.) of the butyl rubber can be from about 25 to about 75, or from about 30 to about 60, or from about 40 to about 55.

In general, the elastomer, in particular the polyolefin elastomer copolymer, may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mw may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. Furthermore, the elastomer, in particular the polyolefin elastomer copolymer, may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mn may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. In general, the molecular weight may be characterized by GPC (gel permeation chromatography) using polystyrene standards.

Furthermore, when a mixture of elastomers is present, the primary elastomer may be present in an amount of about 60 wt. % or more, such as about 70 wt. % or more, such as about 80 wt. % or more, such as about 90 wt. % or more to less than 100 wt. % based on the weight of the elastomer. The secondary elastomer may be present in an amount of 40 wt. % or less, such as 30 wt. % or less, such as 20 wt. % or less, such as 15 wt. % or less, such as 10 wt. % or less, such as 5 wt. % or more to more than 0 wt. % of the elastomer.

Any elastomer or mixture thereof that is capable of being vulcanized (that is crosslinked or cured) can be used as the elastomer (also referred to herein sometimes as the rubber). Reference to a rubber or elastomer may include mixtures of more than one. Useful elastomers typically contain a degree of unsaturation in their polymeric main chain. Some non-limiting examples of these rubbers include polyolefin copolymer elastomers, butyl rubber, natural rubber, styrene-butadiene copolymer rubber (e.g., styrene/ethylene-butadiene/styrene), butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlorohydrin terpolymer rubber, and polychloroprene.

### C. Thermoset Materials

In embodiments, the tube can be formed from thermoset materials, that is monomer, oligomer, and polymer materials that are capable of being cured or crosslinked. Thermoset materials can include further curative agents that, upon activation (e.g., chemical or thermal) induce chemical reactions that create crosslinking between the polymer chains. The crosslinking density of the thermoset material can vary according to the desired end use for the tube. Other suitable thermosetting polymer materials can include silicones, acrylic resins, polyesters, epoxy functional resins, polyurethanes, phenolic resins, amino resins, furan resins, polybenzoxazines, and combinations thereof. In certain embodiments, the tube can be formed from silicone elastomers. In such embodiments, the tube can be formed from an uncured or partially uncured silicone elastomer material.

As described hereinbelow, during heating of the tube material to form an angle therein, the processing heat can further cure (e.g., partially cure or fully cure) the thermoset material.

### D. TPE/TPV Materials

In embodiments, the tube is formed from a thermoplastic elastomer (TPE) material and/or a thermoplastic vulcanizate (TPV) including a combination of a thermoplastic resin an elastomer and, optionally, a curative. For instance, in embodiments the tube can be formed from a TPV material including a combination of thermoplastic resin and elastomer as described hereinabove.

The thermoplastic vulcanizate may generally comprise about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more of the thermoplastic resin. The thermoplastic vulcanizate may comprise about 90 wt. % or less, such as about 80 wt. % or less, such as about 70 wt. % or less, such as about 60 wt. % or less, such as about 50 wt. % or less, such as about 40 wt. % or less of the thermoplastic resin. In another embodiment, such aforementioned weight percentages may be based on the combined weight of the thermoplastic resin and the elastomer combined within the thermoplastic vulcanizate.

The thermoplastic vulcanizate can generally comprise about 2 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 40 wt. % or more, such as about 50 wt. % or more of the elastomer. The thermoplastic vulcanizate may comprise about 90 wt. % or less, such as about 80 wt. % or less, such as about 70 wt. % or less, such as about 60 wt. % or less, such as about 50 wt. % or less, such as about 40 wt. % or less, such as about 35 wt. % or less, such as about 30 wt. % or less, such as about 25 wt. % or less, such as about 20 wt. % or less, such as about 15 wt. % or less of the elastomer. In another embodiment, such aforementioned weight percentages may be based on the combined weight of the thermoplastic resin and the elastomer combined in the thermoplastic vulcanizate.

### i. Curinq Agent

The TPV formulation, in particular the elastomer within the formulation, may undergo dynamic vulcanization wherein the elastomer is at least partially cured. In general, any curing agent that is capable of curing or crosslinking the elastomer may be used. Some non-limiting examples of these curing agents include phenolic resins, peroxides, maleimides, and silicon-containing curing agents. The curing agents may be used with one or more coagents that serve as initiators, catalysts, etc. for purposes of improving the overall cure state of the elastomer. For instance, the curing composition of some embodiments includes one or both of zinc oxide (ZnO) and stannous chloride (SnCl₂).

In general, the phenolic resins may not necessarily be limited. For instance, these may include resole resins made by the condensation of alkyl substituted phenols or unsubstituted phenols with aldehydes, which can be formaldehydes, in an alkaline medium or by condensation of bi-functional phenoldialcohols. The alkyl substituents of the alkyl substituted phenols typically contain 1 to about 10 carbon atoms. Dimethylol phenols or phenolic resins, substituted in para-positions with alkyl groups containing 1 to about 10 carbon atoms can be used. These phenolic curing agents may be thermosetting resins and may be referred to as phenolic resin curing agents or phenolic resins. These phenolic resins may be ideally used in conjunction with a catalyst system. For example, non-halogenated phenol curing resins are used in conjunction with halogen donors and, optionally, a hydrogen halide scavenger. Where the phenolic curing resin is halogenated, a halogen donor is not required but the use of a hydrogen halide scavenger, such as ZnO, can be used.

Peroxide curing agents are generally selected from organic peroxides. Examples of organic peroxides include, but are not limited to, di-tert-butyl peroxide, dicumyl peroxide, t-butylcumyl peroxide, alpha,alpha-bis(tert-butylperoxy)diisopropyl benzene, 2,5 dimethyl 2,5-di(t-butylperoxy)hexane, 1,1-di(t-butylperoxy)-3,3,5-trimethyl cyclohexane, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals and mixtures thereof may be used.

The silicon-containing curing agents generally include silicon hydride compounds having at least two SiH groups. These compounds react with carbon-carbon double bonds of unsaturated polymers in the presence of a hydrosilylation catalyst. Silicon hydride compounds include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof.

As noted above, hydrosilylation curing may be conducted in the presence of a catalyst. These catalysts can include, but are not limited to, peroxide catalysts and catalysts including transition metals of Group VIII. These metals include, but are not limited to, palladium, rhodium, and platinum, as well as complexes of these metals.

In certain embodiments, the curing composition also includes one or both of ZnO and SnCl₂. In one embodiment, the curing composition may include zinc oxide. In another embodiment, the curing composition may include stannous chloride. In a further embodiment, the curing composition may include zinc oxide and stannous chloride.

Coagents may also be employed with the curing agents, such as the phenolic resin and/or peroxides. The coagent may include a multi-functional acrylate ester, a multi-functional methacrylate ester, or combination thereof. In other words, the coagents include two or more organic acrylate or methacrylate substituents. Examples of multi-functional acrylates include diethylene glycol diacrylate, trimethylolpropane triacrylate (TMPTA), ethoxylated trimethylolpropane triacrylate, propoxylated trimethylolpropane triacrylate, propoxylated glycerol triacrylate, pentaerythritol triacrylate, bistrimethylolpropane tetraacrylate, pentaerythritol tetraacrylate, ethoxylated pentaerythritol tetraacrylate, ethoxylated pentaerythritol triacrylate, cyclohexane dimethanol diacrylate, ditrimethylolpropane tetraacrylate, or combinations thereof. Examples of multi-functional methacrylates include trimethylol propane trimethacrylate (TMPTMA), ethylene glycol dimethacrylate, butanediol dimethacrylate, butylene glycol dimethacrylate, diethylene glycol dimethacrylate, polyethylene glycol dimethacrylate, allyl methacrylate, or combinations thereof. The coagent may also include triallylcyanurate, triallyl isocyanurate, triallyl phosphate, sulfur, N-phenyl-bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime, and the like.

Furthermore, an oil can be employed in the cure system. The oil may also be referred to as a process oil, an extender oil, or plasticizer. Useful oils include mineral oils, synthetic processing oils, or combinations thereof and may act as plasticizers. The plasticizers include, but are not limited to, aromatic, naphthenic, and extender oils. Exemplary synthetic processing oils include low molecular weight polylinear alpha-olefins, and polybranched alpha-olefins. Suitable esters include monomeric and oligomeric materials having an average molecular weight below about 2,000 g/mole, or below about 600 g/mole. Specific examples include aliphatic mono- or diesters or alternatively oligomeric aliphatic esters or alkyl ether esters.

The curing composition may be added in one or more locations, including the feed hopper of a melt mixing extruder. In some embodiments, the curing agent and any additional coagents may be added to the TPV formulation together; in other embodiments, one or more coagents may be added to the TPV formulation at different times from any one or more of the curing agents, as the TPV formulation is undergoing processing to form a TPV.

In general, the amount of curing agent present should be sufficient to at least partially vulcanize the elastomer and in some embodiments, to completely vulcanize the elastomer.

### ii. Other Additives

The thermoplastic vulcanizate formulations of some embodiments may optionally further comprise one or more additives. Suitable additional TPV additives include, but are not limited to, plasticizers, process oils, fillers, processing aids, acid scavengers, antioxidants, stabilizers, lubricants, antiblocking agents, anti-static agents, waxes, foaming agents, colorants/pigments, flame retardants and other processing aids and/or the like. In this regard, the resulting thermoplastic vulcanizate may also comprise one or more of such additives.

Any suitable process oil may be included in some embodiments. In particular embodiments, process oils may be selected from: (i) extension oil, that is, oil present in an oil-extended rubber (such as oil present with the elastomer); (ii) free oil, that is, oil that is added during the vulcanization process (separately from any other TPV formulation component such as the elastomer and thermoplastic vulcanizate); (iii) curative oil, that is, oil that is used to dissolve/disperse the curing agents, for example, a curative-in-oil dispersion such as a phenolic resin-in-oil (and in such embodiments, the curing composition may therefore be present in the TPV formulation as the curative-in-oil additive); and (iv) any combination of the foregoing oils from (i)-(iii). Thus, process oil may be present in a TPV formulation as part of another component (e.g., as part of the elastomer when the process oil is an extension oil, such that the elastomer comprises elastomer and extension oil; or as part of the curing composition when the process oil is the carrier of a curative-in-oil, such that the curing composition comprises the curative oil and a curing agent). On the other hand, process oil may be added to the TPV separately from other components, i.e., as free oil.

The extension oil, free oil, and/or curative oil may be the same or different oils in various embodiments. Process oils may include one or more of (i) “refined” or “mineral” oils, and (ii) synthetic oils. As used herein, mineral oils refer to any hydrocarbon liquid of lubricating viscosity (i.e., a kinematic viscosity at 100° C. of 1 mm²/sec or more) derived from petroleum crude oil and subjected to one or more refining and/or hydroprocessing steps (such as fractionation, hydrocracking, dewaxing, isomerization, and hydrofinishing) to purify and chemically modify the components to achieve a final set of properties. Such “refined” oils are in contrast to “synthetic” oils, which are manufactured by combining monomer units into larger molecules using catalysts, initiators, and/or heat.

In general, either refined or synthetic process oils according to some embodiments may include, but are not limited to, any one or more of aromatic, naphthenic, and paraffinic oils. Exemplary synthetic processing oils are polylinear alpha-olefins, polybranched alpha-olefins, and hydrogenated polyalphaolefins. The compositions of some embodiments of this disclosure may include organic esters, alkyl ethers, or combinations thereof.

In certain embodiments, at least a portion of the process oil (e.g., all or a portion of any one or more of extension oil, free oil, and/or curative oil) is a low aromatic/sulfur content oil and has (i) an aromatic content of less than 5 wt. %, or less than 3.5 wt. %, or less than 1.5 wt. %, based on the weight of that portion of the process oil; and (ii) a sulfur content of less than 0.3 wt. %, or less than 0.003 wt. %, based on the weight of that portion of the process oil. Aromatic content may be determined in a manner consistent with method ASTM D2007. The percentage of aromatic carbon in the process oil of some embodiments is preferably less than 2, 1, or 0.5%. In certain embodiments, there are no aromatic carbons in the process oil. The proportion of aromatic carbon (%) as used herein is the proportion (percentage) of the number of aromatic carbon atoms to the number of all carbon atoms determined by the method in accordance with ASTM D2140.

Suitable process oils of particular embodiments may include API Group I, II, III, IV, and V base oils. See API 1509, Engine Oil Licensing and Certification System, 17th Ed., September 2012, Appx. E, incorporated herein by reference.

A TPV formulation of some embodiments may also or instead include a polymeric processing additive. The processing additive employed in such embodiments is a polymeric resin that has a very high melt flow index. These polymeric resins include both linear and branched molecules that have a melt flow rate that is greater than about 500 dg/min, more preferably greater than about 750 dg/min, even more preferably greater than about 1000 dg/min, still more preferably greater than about 1200 dg/min, and still more preferably greater than about 1500 dg/min. The thermoplastic elastomers of the present disclosure may include mixtures of various branched or various linear polymeric processing additives, as well as mixtures of both linear and branched polymeric processing additives. Reference to polymeric processing additives will include both linear and branched additives unless otherwise specified. The preferred linear polymeric processing additives are polypropylene homopolymers. The preferred branched polymeric processing additives include diene-modified polypropylene polymers.

In addition, the formulation may also include reinforcing and/or non-reinforcing fillers. Fillers and extenders that can be utilized include conventional inorganics such as calcium carbonate, clays, silica, talc, titanium dioxide, as well as organic, such as carbon black, graphene, and organic and inorganic nanoscopic fillers.

In certain embodiments, the TPV formulation may include acid scavengers. These acid scavengers may be added to the thermoplastic vulcanizate after the desired level of cure has been achieved. Preferably, the acid scavengers are added after dynamic vulcanization. Useful acid scavengers include hydrotalcites. Both synthetic and natural hydrotalcites can be used. An exemplary natural hydrotalcite can be represented by the formula Mg₆Al₂(OH)₁₆CO₃·4H₂O. Synthetic hydrotalcite compounds may have formula Mg_{4.3}Al₂(OH)₁₂·6CO₃·mH₂O or Mg_{4.5}Al₂(OH)₁₃CO₃·3.5H₂O.

These additives can be utilized in an amount to provide the desired effect. In this regard, the additives may be present in an amount of up to about 50 weight percent of the total TPV formulation or TPV. In this regard, a respective additive and/or combination of additives may be present in an amount of 0.001 wt. % or more, such as 0.01 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 3 wt. % or more, such as 5 wt. % or more, such as 8 wt. % or more, such as 10 wt. % or more, such as 12 wt. % or more, such as 15 wt. % or more, such as 20 wt. % or more, such as 25 wt. % or more, such as 30 wt. % or more. They may be present in an amount of 50 wt. % or less, such as 40 wt. % or less, such as 30 wt. % or less, such as 25 wt. % or less, such as 20 wt. % or less, such as 18 wt. % or less, such as 15 wt. % or less, such as 13 wt. % or less, such as 10 wt. % or less, such as 8 wt. % or less, such as 6 wt. % or less, such as 4 wt. % or less, such as 3 wt. % or less, such as 2 wt. % or less, such as 1 wt. % or less, such as 0.5 wt. % or less. In another embodiment, such aforementioned percentages may be based on the weight of the thermoplastic resin. In a further embodiment, such aforementioned percentages may be based on the weight of the elastomer. In an even further embodiment, such aforementioned percentages may be based on the combined weight of the thermoplastic resin and elastomer.

### iii. TPV Formulation

In general, as used herein, a “TPV formulation” refers to the mixture of ingredients blended or otherwise compiled before or during processing of the TPV formulation in order to form a TPV. This is in recognition of the fact that the ingredients that are mixed together and then processed may or may not be present in the final TPV in the same amounts added to the formulation, depending upon the reactions that take place among some or all of the ingredients during processing of the mixed ingredients.

In general, a TPV formulation according to various embodiments includes the elastomer, thermoplastic resin, and curing agent (or curing composition) along with any other optional additives. As will be discussed in more detail below, the TPV formulation undergoes processing, including dynamic vulcanization, to form a TPV. In certain embodiments, any other additives may be added to the TPV formulation during processing, either before or after dynamic vulcanization.

Relative amounts of the various components in TPV formulations are conveniently characterized based upon the amount of elastomer in the formulation, in particular in parts by weight per hundred parts by weight of rubber (phr). In embodiments wherein the elastomer comprises both elastomer with an extension oil, as is common for much commercially available elastomers such as EPDM, the phr amounts are based only upon the amount of elastomer, exclusive of extension oil present with the elastomer. Thus, as an example, an elastomer containing 100 parts EPDM (rubber) and 75 parts extension oil would in fact be considered present in a TPV formulation at 175 phr (i.e., on the basis of the 100 parts EPDM rubber). If such a TPV formulation were further characterized as containing 50 phr thermoplastic resin, the formulation would include 50 parts by weight of thermoplastic resin in addition to the 100 parts by weight elastomer and 75 parts by weight extension oil.

TPV formulations of some embodiments may include the thermoplastic resin in an amount from about 20 to about 300 parts per hundred parts by weight of the elastomer or rubber (phr). In various embodiments, the thermoplastic resin is included in a TPV formulation in an amount ranging from a low of any one of about 20, 25, 30, 35, 40, 45, 50, 55, 60, 65, 70, 75, 80, 85, 90, 95, 100, 105, 110, 115, 120, 125, 130, 135, 140, 145, 150, 165, 170, and 175 phr, to a high of any one of about 100, 125, 150, 175, 200, 225, 250, 275, and 300 phr. The thermoplastic resin may be included in an amount ranging from any of the aforementioned lows to any of the aforementioned highs, provided that the high value is greater than or equal to the low value. In particular embodiments, increasing amounts of thermoplastic resin correspond to increasing hardness of the dynamically vulcanized TPV.

When the elastomer consists of elastomer only, it is by definition present at 100 phr (since it is the basis of the phr notation). However, in embodiments wherein the elastomer component comprises a constituent other than an elastomer, such as an extender oil, the elastomer may be included in a TPV formulation in an amount ranging from a low of any one of about 100.05, 100.1, 100.15, 100.2, 105, 110, 115, and 120 phr to a high of any one of about 110, 120, 125, 150, 175, 200, 225, and 250 phr.

As previously noted, TPV formulations of certain embodiments may optionally include additional TPV additives. Amounts of additional additive are separate and in addition to those additives already included in another component of a TPV formulation. For instance, any additive such as extension oil included with the elastomer has already been accounted for as part of the amount of elastomer added to the formulation; recited amounts of additional additives therefore are exclusive of additives already included with the elastomer. Additional additives may be present in a TPV formulation in the aggregate in an amount ranging from about 0 phr to about 300 phr. In certain embodiments, additional additives may in the aggregate be present in the TPV in an amount ranging from a low of any one of about 0, 5, 10, 15, 25, 30, 40, 50, 60, 70, 80, 90, and 100 phr, to a high of any one of about 25, 30, 40, 50, 60, 80, 100, 125, 150, 175, 200, 225, 250, 275, and 300 phr. The additional additives may be included in an aggregate amount ranging from any one of the aforementioned lows to any one of the aforementioned highs, provided that the high value is greater than or equal to the low value. In one embodiment, such aforementioned phr may refer to the additional additives individually rather than the aggregate.

For convenience, components of TPV formulations of various embodiments may alternatively be characterized based upon their weight percentages in the TPV formulation according to the following:

The thermoplastic resin(s) may be present in a TPV formulation in amounts ranging from a low of any one of about 5, 6, 7, 8, 9, 10, 11, 12, 13, 14, 15, 16, 17, 18, 19, 20, 21, 22, 23, 24, and 25 wt. % to a high of any one of about 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, and 60 wt. %, provided that the high is greater than or equal to the low.

The elastomer(s) may be present in a TPV formulation in amounts ranging from a low of any one of about 3, 4, 5, 6, 7, 8, 9, 10, 11, 12, 13, 14, 15, 16, 17, 18, 19, 20, 25, 30, and 35 wt. % to a high of any one of about 35, 40, 45, 50, 55, 60, 65, 70, 75, and 80 wt. %, provided that the high is greater than or equal to the low, and that the elastomeric(s) are present in the TPV formulation within the range of about 20 to about 300 phr.

The optional additional TPV additive(s) may be present in a TPV formulation in aggregate amounts ranging from a low of any one of about 0, 5, 10, 15, 20, 25, 30, 35, and 40 wt. % to a high of any one of about 30, 35, 40, 45, 50, 55, 60, and 65 wt. %, provided that the high is greater than or equal to the low, and that the additive(s) are present in the TPV formulation within the range of about 0 to about 300 phr.

### iv. Processing TPV Formulations

The thermoplastic vulcanizate of the present disclosure is prepared by dynamic vulcanization techniques. The term “dynamic vulcanization” refers to a vulcanization or curing process for a TPV formulation comprising an elastomer, wherein the elastomer is vulcanized under conditions of high shear mixing at a temperature above the melting point of the thermoplastic resin to produce a thermoplastic vulcanizate. In dynamic vulcanization, an elastomer is simultaneously crosslinked and dispersed as fine particles within the thermoplastic resin or matrix, although other morphologies, such as co-continuous morphologies, may exist depending on the degree of cure, the elastomer to resin viscosity ratio, the intensity of mixing, the residence time, and the temperature.

In some embodiments, processing may include melt blending, in a chamber, a TPV formulation comprising the elastomer, thermoplastic resin, and curing agent. The chamber may be any vessel that is suitable for blending the selected composition under temperature and shearing force conditions necessary to form a thermoplastic vulcanizate. In this respect, the chamber may be a mixer, such as Banbury™ mixers or Brabender™ mixers, and certain mixing extruders such as co-rotating, counter-rotating, and twin-screw extruders, as well as co-kneaders, such as Buss® kneaders. According to one embodiment, the chamber is an extruder, which may be a single or multi-screw extruder. The term “multi-screw extruder” means an extruder having two or more screws; with two and three screw extruders being exemplary, and two or twin screw extruders being preferred in some embodiments. The screws of the extruder may have a plurality of lobes; two and three lobe screws being preferred. It will readily be understood that other screw designs may be selected in accordance with the methods of embodiments of the present disclosure. In some embodiments, dynamic vulcanization may occur during and/or as a result of extrusion. After discharging from the mixer, the blend containing the vulcanized rubber and the thermoplastic can be milled, chopped, extruded, pelletized, injection-molded, or processed by any other desirable technique.

The dynamic vulcanization of the elastomer may be carried out to achieve relatively high shear. In particular embodiments, the blending may be performed at a temperature not exceeding about 400° C., preferably not exceeding about 300° C., and more preferably not exceeding about 250° C. The minimum temperature at which the melt blending is performed is generally higher than or equal to about 130° C., preferably higher than or equal to about 150° C. and more particularly higher than about 180° C. The blending time is chosen by taking into account the nature of the compounds used in the TPV formulation and the blending temperature. The time generally varies from about 5 seconds to about 120 minutes, and in most cases from about 10 seconds to about 30 minutes.

Dynamic vulcanization in some embodiments may include phase inversion. As those skilled in the art appreciate, dynamic vulcanization may begin by including a greater volume fraction of rubber than thermoplastic resin. As such, the thermoplastic resin may be present as the discontinuous phase when the rubber volume fraction is greater than that of the volume fraction of the thermoplastic resin. As dynamic vulcanization proceeds, the viscosity of the rubber increases and phase inversion occurs under dynamic mixing. In other words, upon phase inversion, the thermoplastic resin phase becomes the continuous phase.

Other additive(s) are preferably present within the TPV formulation when dynamic vulcanization is carried out, although in some embodiments, one or more other additives (if any) may be added to the composition after the curing and/or phase inversion (e.g., after the dynamic vulcanization portion of processing). The additional additives may be included after dynamic vulcanization by employing a variety of techniques. In one embodiment, they can be added while the thermoplastic vulcanizate remains in its molten state from the dynamic vulcanization process. For example, the additional additives can be added downstream of the location of dynamic vulcanization within a process that employs continuous processing equipment, such as a single or twin screw extruder. In other embodiments, the thermoplastic vulcanizate can be “worked-up” or pelletized, subsequently melted, and the additional additives can be added to the molten thermoplastic vulcanizate product. This latter process may be referred to as a “second pass” addition of the ingredients.

Despite the fact that the elastomer may be partially or fully cured, the thermoplastic vulcanizate can be processed and reprocessed by conventional plastic processing techniques such as extrusion, injection molding, and compression molding. The elastomer within these thermoplastic elastomers is usually in the form of finely-divided and well-dispersed particles of vulcanized or cured rubber within a continuous thermoplastic phase or matrix, although a co-continuous morphology or a phase inversion is also possible. In those embodiments where the cured rubber is in the form of finely-divided and well-dispersed particles within the thermoplastic medium, the rubber particles may have an average diameter that is less than 50 μm, such as less than 30 μm, such as less than 10 μm, such as less than 5 μm, such as less than 1 μm. In preferred embodiments, at least 50%, such as at least 60%, such as at least 75% of the rubber particles may have an average diameter of less than 5 μm, such as less than 2 μm, such as less than 1 μm.

The degree of cure can be measured by determining the amount of rubber that is extractable from the thermoplastic vulcanizate by using cyclohexane or boiling xylene as an extractant. Preferably, the rubber may have a degree of cure where not more than 15 weight percent, such as not more than 10 weight percent, such as not more than 5 weight percent, such as not more than 3 weight percent is extractable by cyclohexane at 23° C. as described in U.S. Pat. Nos. 4,311,628, 5,100,947 and 5,157,081, all of which are incorporated herein by reference. Alternatively, the rubber may have a degree of cure such that the crosslink density is at least 4×10⁻⁵, such as at least 7×10⁻⁵, such as at least 10×10⁻⁵ moles per milliliter of rubber. See Crosslink Densities and Phase Morphologies in Dynamically Vulcanized TPEs, by Ellul et al., Rubber Chemistry and Technology, Vol. 68, pp. 573-584 (1995).

The resulting thermoplastic vulcanizate may have the desired density that allows it to be utilized for a molded part as described herein. In this regard, the density may be 0.3 g/cm³ or more, such as 0.4 g/cm³ or more, such as 0.5 g/cm³ or more, such as 0.6 g/cm³ or more, such as 0.65 g/cm³ or more, such as 0.7 g/cm³ or more, such as 0.75 g/cm³ or more, such as 0.8 g/cm³ or more, such as 0.85 g/cm³ or more, such as 0.9 g/cm³ or more, such as 0.95 g/cm³ or more, such as 1 g/cm³ or more, such as 1.05 g/cm³ or more, such as 1.1 g/cm³ or more, such as 1.15 g/cm³ or more, such as 1.2 g/cm³ or more. The density may be 2 g/cm³ or less, such as 1.8 g/cm³ or less, such as 1.6 g/cm³ or less, such as 1.4 g/cm³ or less, such as 1.3 g/cm³ or less, such as 1.2 g/cm³ or less, such as 1.1 g/cm³ or less, such as 1.0 g/cm³ or less, such as 0.95 g/cm³ or less, such 0.90 g/cm³ or less, such as 0.7 g/cm³ or less, such as 0.6 g/cm³ or less, such as 0.55 g/cm³ or less.

Once formed, the thermoplastic vulcanizate may be shaped into the form of a molded part, in particular a tube as described herein, using any of a variety of techniques as is known in the art. For instance, the thermoplastic vulcanizate can advantageously be fabricated by employing typical molding processes, such as injection molding, extrusion molding, compression molding, blow molding, rotational molding, overmolding, etc. In general, these processes include heating the thermoplastic vulcanizate to a temperature that is equal to or in excess of the melt temperature of the thermoplastic resin to form a pre-form for a mold cavity to then form the molded part, cooling the molded part to a temperature at or below the crystallization temperature of the thermoplastic vulcanizate, and releasing the molded part from a mold. The mold cavity defines the shape of the molded part, such as the tube. The molded part is cooled within the mold at a temperature at or below the crystallization temperature of the thermoplastic vulcanizate and the molded part can subsequently be released from the mold. The process may also utilize extrusion molding to form the tube. In this regard, the thermoplastic vulcanizate may be extruded as described herein. Upon exiting the extruder, the thermoplastic vulcanizate may be formed or shaped to form the tube. Such tube may be formed by using a particular die to shape the thermoplastic vulcanizate as it exits the extruder. Such shaping/forming process, such as the extrusion process, may be an automated or robotic process.

### E. Tube Configurations

The tube can include a single layer tube, or a tube formed from multiple layers of materials. For instance, the tube can include layers of materials, the layers being, for example, polymeric, metallic, and composite layers. For fluid containment, many tubes include an inner layer that contacts the fluid being transported in the tube, thus the inner layer is often formed from a material having good resistance to physical and chemical degradation, resistance to hydrolysis, and low permeability to various fluids that are transported. The tube can include a reinforcement layer surrounding the inner layer and an outer layer disposed on the reinforcement layer. The reinforcement layer can include a variety of materials, metal mesh, etc. to provide strength and stability to the tube. The tube can include braided or reinforced materials in order to add strength and stability to the tube. For instance, the tube can include polyester yarns that are braided or unbraided to reinforce the hose. In other embodiments, fibers, such as short or long glass or aramid fibers can be used to reinforce the tube. The material layers of the tube can be co-extruded or bonded via suitable adhesive materials. In embodiments, at least one layer of the tube is formed from a thermoplastic vulcanizate.

In embodiments, the tube can include

### III. Methods for Forming a Tube

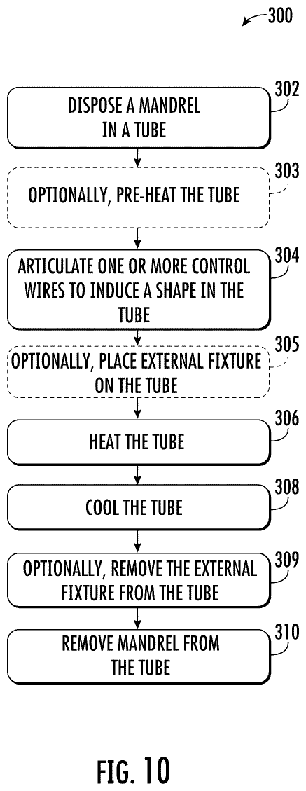

FIG. 10 depicts a flow diagram of one example method of forming a tube (300) according to the present disclosure. As will be understood, the mandrels as disclosed herein can be utilized to shape and form a tube. Any of the mandrels disclosed hereinabove with respect to FIGS. 1-9 can be utilized in the methods as disclosed.

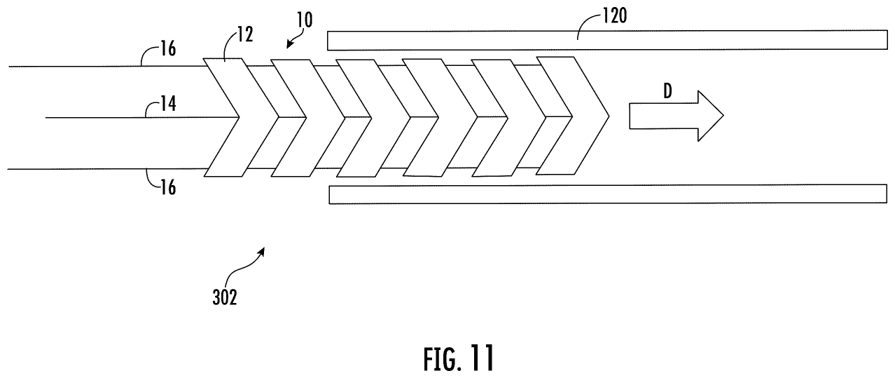

At (302) and as shown in FIG. 11, the method includes disposing a mandrel 10 in a tube 120. The tube can be formed from a TPV material as disclosed hereinabove. The mandrel 10 includes a plurality of discs 12 spaced apart from each other along a length of a guide wire 14. One or more control wires 16 are also disposed through the discs 12, such as in a peripheral portion of the discs 12. The mandrel 10 can be inserted into the tube 120 according to the direction of arrow D. To facilitate insertion of the mandrel 10 in the tube 120, components of the mandrel 10 (e.g., discs 12, guide wire 14, control wires 16) can be coated with a lubricant. The discs 12 can be formed from a low friction material as described herein above to further facilitate insertion of the mandrel 10 into the tube 120.

After insertion of the mandrel 10 in the tube 120, in embodiments, there is a distance between the inner surface of the tube 120 and the outer surface of the mandrel 10 (e.g., the discs 12). Such a distance can range from about 0.1 mm to about 2 mm, from about 0.5 mm to about 1 mm, such as from about 0.6 mm to about 0.8 mm. Providing this distance between the mandrel 10 and the tube 120, ensures there is room for expansion of the tube material during heating. If the distance between the mandrel and inner surface of the tube 120 is too close, during expansion, the tube material could press against the mandrel 10 forming an indentation or other deformation. Thus, ensuring a proper distance between the mandrel 10 and the tube material can reduce deformities (e.g., indentations) on the tube.

Optionally, at (303), the tube 120 can be preheated. For instance, once the mandrel 10 is inserted in the tube 120, the tube 120 can be preheated to a preheat temperature ranging from about 50° C. to about 100° C., such as 55° C. to about 80° C., such as from about 75° C. to about 90° C. The tube 120 can be preheated for a time ranging from about 1 minute to about 30 minutes, such as from about 5 minutes to about 25 minutes, such as from about 10 minutes to about 20 minutes. It should be appreciated that preheating at (303) can take place at any point in the method (300) prior to heating at (306).

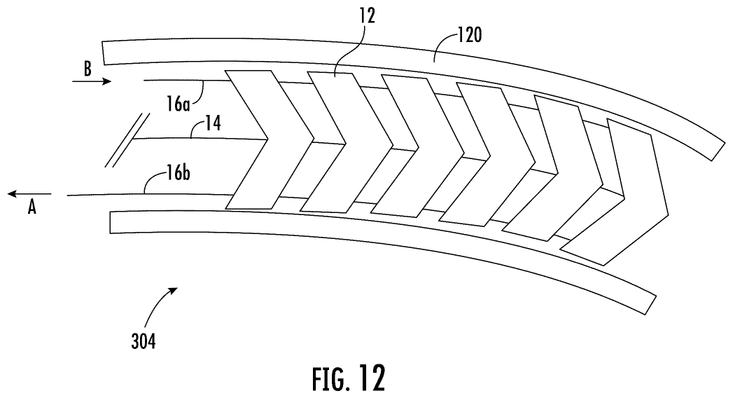

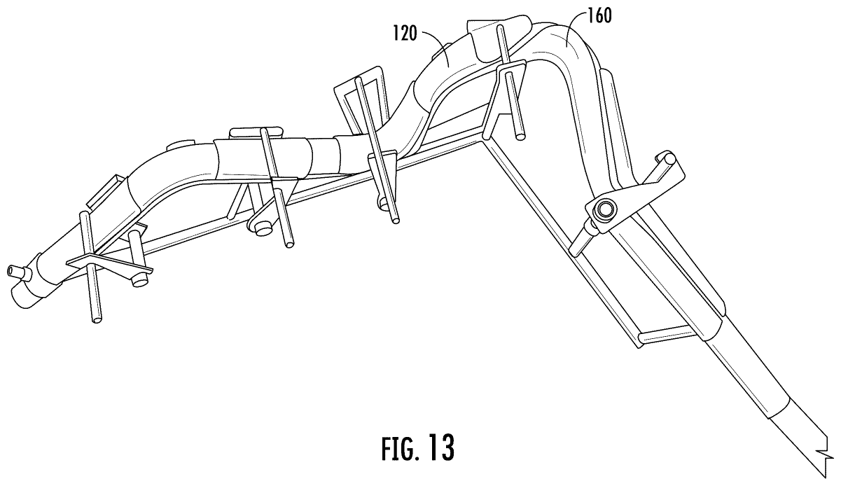

At (304) and as shown in FIG. 12, one or more control wires 16 of the mandrel 10 can be articulated to adjust the shape of the tube 120. For instance, an angle or bend can be introduced into the tube 120 by articulating the first control wire 16a in the direction of arrow B and/or by articulating the second control wire 16b in the direction of arrow A. Articulation of the control wires 16 causes the discs 12 to change position, orientation, and/or shape within the tube 120, thus introducing a bend or angle in the tube 120. The control wires 16a, 16b can be articulated (e.g., pulled) to a certain length or tightness to bend the tube 120 according to a desired angle.

Actuation of the control wires 16 and/or guide wire 14 can be controlled or implemented via an automated process. For instance, one or more mechanical actuators (e.g., hydraulics, motors, reels, etc.) can be operated to move the control wires 16 of the mandrel 10 inside of the tube 120. The mechanical actuators can include any mechanical device capable of manipulating the control wire 16 or guide wire 14 to move one or more components (e.g., discs 12) of the mandrel 10. The mechanical actuators can be controlled by a programmable controller. For instance, a controller can be coupled to various components of the mandrel 10 to operate the components in a desired manner. For example, the discs 12 can be moved to different positions within the tube 120 by control wires 16 controlled via the controller. Further, angles (e.g., bend radii) and locations of the angles along the length of the tube 120 can be determined and provided to the controller. The controller can then operate one or more mechanical actuators to guide one or more mandrels 10 within the tube 120 to the desired locations and actuate the control wires 16 until the desired input angle (e.g., bend radius) is achieved. The controller can include one or more processors and one or more memory devices. The memory device can store and implement computer readable instructions that when executed by the one or more processors cause the one or more processors to perform operations, including implementing any of the control functionality of the present disclosure. Accordingly, when the desired angle is provided to the controller 175, the controller can operate the mechanical actuators in order to move the mandrel 10 such that the desired angle is achieved in the tube 120. Further, the guide wire 14 can be operated by the controller to insert and place the mandrel 10 in a desired location within the tube 120. Thus, in embodiments, bending the tube 120 can be a partially or fully automated process.

In embodiments, during bending of the tube 120, a desired bending radius can be imparted on the tube 120 to form a desired angle. Given different tube materials, in embodiments, the bend radius can be modified in order to account for any spring back based on the selected material for the tube 120. For instance, if elastomers are used in the tube 120, these materials possess shape memory and have a tendency to spring back to the original shape even after processing. Accordingly, the bend radius for the desired angle can be modified to account for the elastomeric shape memory of the material. For instance, the bend radius can be modified+/−1° up to about 5°. For instance, where an angle of 120° is desired, the mandrel 10 can be used to bend the tube 120 to an angle ranging from 115° to about 119° prior to processing (e.g., heating and cooling) to set the angle of the tube 120. In other embodiments, where the desired angle for the tube 120 is 90° and, the mandrel 10 is used to bend the tube 120 to an angle of between about 86° to about 89°. In other embodiments, the desired angle for the tube 120 can be about 150°, and the mandrel 10 is used to bend the tube 120 to an angle of between about 148° to about 149°. Notably, in embodiments, the mandrel 10 can be used to bend the tube 120 to an angle that is less than the desired angle, in order to account for elastomeric spring back of the material.

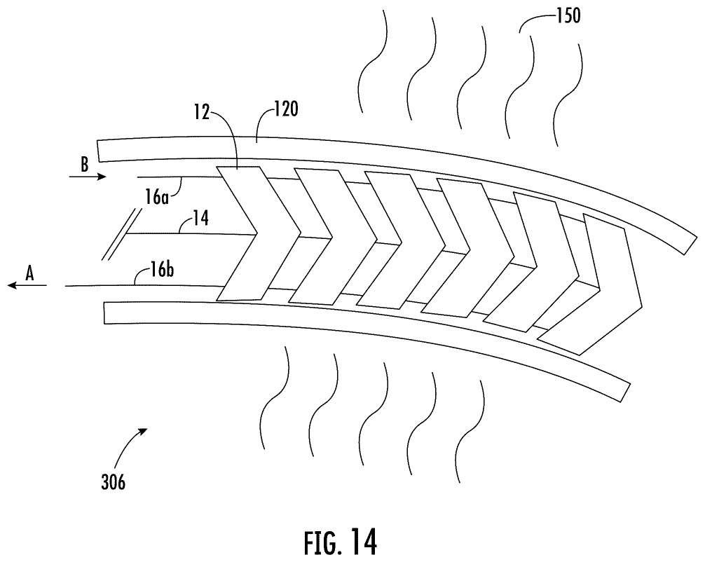

Optionally at (305) and as shown in FIG. 13, an external fixture 160 can be placed on the tube 120 to secure the tube 120. For instance, the external fixture 160 can be machined from metal and can be used to secure the entire length or at least a portion of the length of the tube 120 during processing. When placed around a portion of the external surface of the tube 120, a distance is located between surfaces of the external fixture 160 adjacent to the tube 120 and the external surface of the tube 120. The distance between the external fixture 160 and the tube 120 can range from about 0.5 mm to about 2 mm, such as from about 0.8 mm to about 1.7 mm, such as from about 1 mm to about 1.5 mm. Ensuring proper distance between the external fixture 160 and the tube 120 allows for expansion of the tube material. For instance, if the tube material presses against the external fixture 160, indentation or deformation of the external surface of the tube 120 could occur. As such, ensuring a proper distance between the external fixture 160 and the tube 120 reduces surface deformities (e.g., indentations) on the external surface of the tube 120.

At (306) and as shown in FIG. 14, the tube 120 can be heated. For instance, heat 150 can be applied to the tube 120 as shown. To introduce heat 150 to the tube 120, the tube 120 can be placed in an oven, chamber, or other suitable location where heat 150 can be applied to the tube 120. Optionally, heat 150 can be exposed to the outer surface of the tube 120 and to the inner surface of the tube 120. Heat 150 can be provided by conventional heating methods including hot air, steam, autoclave, etc. In certain embodiments, electromagnetic radiation is exposed to the tube 120 to heat the tube 120. For example, infrared radiation can be exposed to the tube 120. As used herein “infrared radiation” refers to electromagnetic radiation having wavelengths ranging between about 780 nm to about 1000 μm. The tube 120 can be exposed to the heat 150 for a desired heating time. The heating time can range from about 5 minutes to about 1 hour, from about 15 minutes to about 45 minutes, such as from about 20 minutes to about 30 minutes. In embodiments, the heating time is about 40 minutes or less, such as about 30 minutes or less, such as about 20 minutes or less.

Depending on the material of the tube 120, processing temperatures can vary. In embodiments where the tube 120 includes a thermoplastic material component, the processing temperature is less than the softening or melting temperature of the thermoplastic material. In embodiments, the tube can be heated to a processing temperature ranging from about 110° C. to about 190° C., such as from about 130° C. to about 170° C., such as from about 120° C. to about 160° C. In embodiments, the processing temperature can range from about 110° C. to about 130° C. In other embodiments, the processing temperature ranges from about 150° C. to about 160° C.

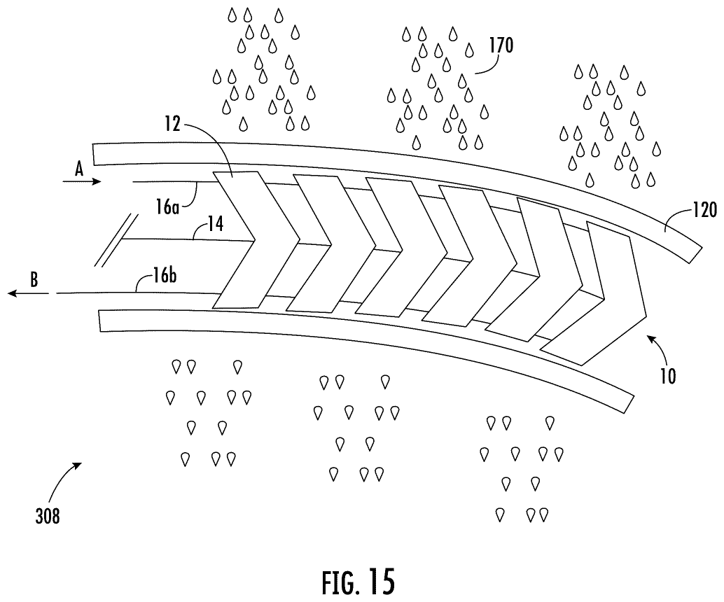

At (308) and as shown in FIG. 15, the tube 120 can be cooled. For example, a cooling source 170 can be applied to the tube 120 to reduce the temperature of the tube 120. Importantly, the mandrel 10 remains in the tube 120 during cooling to ensure that the tube 120 is held in the desired shape and that the desired angle or bend radius of the tube 120 is held until the tube material reaches a temperature below its deformation temperature. Similarly, the external fixture 160 can also remain secured to the tube 120 during cooling. The cooling source 170 can include cooled air or cooled fluid, which includes fluids and air that are cooler than ambient temperature (e.g., less than 22° C.). The cooling source 170 can be exposed to the tube 120 for a cooling time. The cooling time can range from about 15 minutes to about 45 minutes, such as from about 20 minutes to about 40 minutes, such as from about 22 minutes to about 32 minutes. In embodiments, the cooling time is less than or about 30 minutes. During cooling, the tube 120 can be exposed to a cooling temperature ranging from about 0° C. to about 30° C., such as from about 10° C. to about 20° C.

Optionally, at (309) the external fixture 160 is removed from the tube 120. For instance, portions of the external fixture 160 can be disassembled and removed from the external surface of the tube 120.

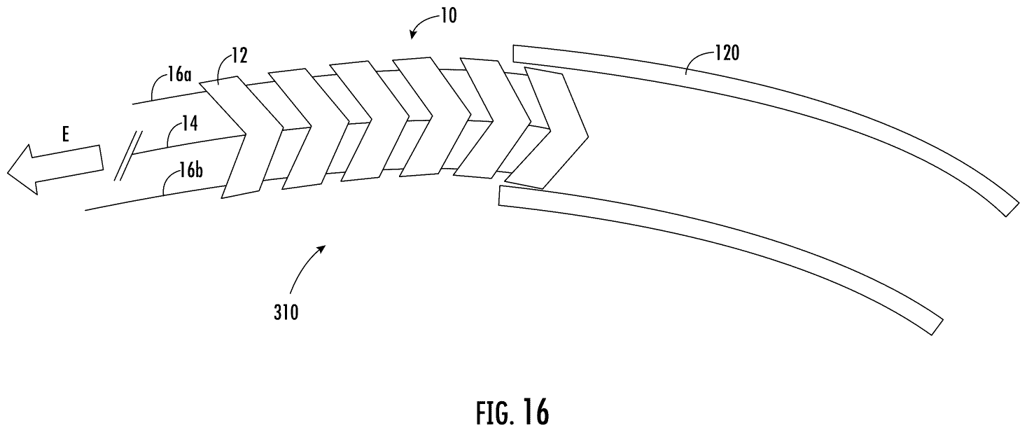

At (310) and as shown in FIG. 16, the mandrel 10 is removed from the tube 120. For instance, the mandrel 10 can be removed from the tube 120 in the direction indicated by arrow E. In embodiments, compressed air or vacuum pressure can be applied inside of the tube 120 to facilitate removal of the mandrel 10 from the tube 120. In other embodiments, lubricant can be applied inside the tube 120 to facilitate removal of the mandrel 10. Once the mandrel 10 is removed, the mandrel 10 can be reshaped and used immediately in other tubes to facilitate shaping of additional tubes.

The following test methods may be employed to determine the properties referenced herein.

### Test Methods

Melting Temperature, Glass Transition Temperature, Heat of Fusion: The melting temperature (“Tm”), glass transition temperature (“Tg”), and the heat of fusion (“Hf”) may be determined by differential scanning calorimetry (“DSC”) as is known in the art using commercially available equipment such as a TA instruments Model 0100. Typically, 6 to 10 mg of the sample, that has been stored at room temperature (about 23° C.) for at least 48 hours, is sealed in an aluminum pan and loaded into the instrument at room temperature (about 23° C.). The sample is equilibrated at 25° C. and then it is cooled at a cooling rate of 10° C./min to −80° C. The sample is held at −−80° C. for 5 min and then heated at a heating rate of 10° C./min to 25° C. The glass transition temperature is measured from this heating cycle (“first heat”). For samples displaying multiple peaks, the melting point (or melting temperature) is defined to be the peak melting temperature associated with the largest endothermic calorimetric response in that range of temperatures from the DSC melting trace. The T_{g} was measured by again heating the sample from −80° C. to 80° C. at a rate of 20° C./min (“second heat”). The glass transition temperature reported is the midpoint of step change when heated during the second heating cycle. Areas under the DSC curve are used to determine the heat of transition (heat of fusion, Hf, upon melting or heat of crystallization, Hc, upon crystallization, if the Hf value from the melting is different from the He value obtained for the heat of crystallization, then the value from the melting (Tm) shall be used), which can be used to calculate the degree of crystallinity (also called the percent crystallinity). The percent crystallinity (X %) is calculated using the formula: [area under the curve (in J/g)/H° (in J/g)]*100, where H° is the heat of fusion for the homopolymer of the major monomer component. These values for H° are to be obtained from the Polymer Handbook, Fourth Edition, published by John Wiley and Sons, New York 1999, except that a value of 290 J/g is used as the equilibrium heat of fusion (H°) for 100% crystalline polyethylene, a value of 140 J/g is used as the equilibrium heat of fusion (H°) for 100% crystalline polybutene, and a value of 207 J/g (H°) is used as the heat of fusion for a 100% crystalline polypropylene.

### Definitions

It will be understood that when an element or component is referred to as being “on,” “connected to” or “coupled to” another element or component, it can be directly on, connected or coupled to the other element or component or intervening elements or components may be present. In contrast, when an element is referred to as being “directly on,” “directly connected to” or “directly coupled to” another element or component, there are no intervening elements or components. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concepts.

The terminology used herein is for the purpose of describing particular example embodiments only and is not intended to be limiting of the present inventive concepts. As used herein, the singular forms “a,” “an” and “the” are intended to include the plural forms as well, unless the context clearly indicates otherwise. It will be further understood that the terms “comprises”, “includes”, “including” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, “optional” or “optionally” means that the subsequently described event or circumstance does or does not occur, and that the description includes instances where said event or circumstance occurs and instances where it does not. For example, an optional component in a system means that the component may be present or may not be present in the system.

For purposes of this disclosure, the term “tube” can include and/or be referred to as “conduit”, “pipe”, “hose”, and the like.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

What is claimed is:

1. A mandrel for the manufacture of a tube, comprising:
one or more discs spaced apart from each other;
one or more guide wires coupled to one or more of the discs;
one or more control wires coupled to one or more of the discs, wherein articulation of one or more of the control wires induces a shape change in the tube.

2. The mandrel of claim 1, wherein the one or more guide wires comprise a first guide wire disposed through a center of each of the one or more discs.

3. The mandrel of claim 1, wherein the one or more control wires comprise a first control wire disposed through a peripheral portion of the one or more discs.

4. The mandrel of claim 3, comprising a second control wire disposed in a peripheral portion of the one or more discs opposite from the first control wire.

5. The mandrel of claim 1, further comprising a lubricant disposed on the discs, the one or more guide wires, and/or the one or more control wires.

6. The mandrel of claim 1, wherein the discs comprise a body having a first tapered end and a second tapered end.

7. The mandrel of claim 6, wherein a first control wire is disposed through the first tapered end, a second control wire is disposed through the second tapered end, and a first guide wire is disposed through a center of the body.

8. The mandrel of claim 1, wherein the discs are coupled via one or more joints.

9. The mandrel of claim 8, wherein the one or more joints comprise ball joints.

10. The mandrel of claim 1, wherein each of the discs comprise a curved body have a first tapered arm and a second tapered arm, wherein a protrusion extends from a first side of the disc.

11. The mandrel of claim 1, wherein the one or more discs comprise a first disc having a disc body containing one or more cavities disposed therein, wherein articulation of one or more of the control wires forms and angle in the disc body and seals the cavities forming a solid external surface on the disc body.

12. The mandrel of claim 1, comprising a covering disposed adjacent to one or more external surfaces of the one or more discs.

13. The mandrel of claim 12, wherein the covering comprises a coiled spring.

14. The mandrel of claim 1, comprising one or more skirting panels disposed on an outer portion of the discs.

15. The mandrel of claim 1, comprising one or more groupings of the one or more discs spaced apart from each other along a length of the guide wire.

16. A method for forming a tube, the method comprising:
disposing the mandrel of claim 1 in the tube;
articulating the one or more of the control wires to induce a shape change in the tube;
heating the tube to a first temperature with the mandrel disposed therein;
cooling the tube to a second temperature; and
removing the mandrel from the tube.

17. The method of claim 16, comprising prior to heating the tube to a first temperature, preheating the tube to a preheat temperature.

18. The method of claim 16, wherein heating the tube comprises exposing the tube to infrared radiation, hot air, and/or steam.

19. The method of claim 16, wherein heating the tube comprises exposing an outer surface of the tube to heat and exposing an inner surface of the tube to heat.

20. The method of claim 16, wherein removing the mandrel from the tube comprises exposing an interior of the tube to vacuum or compressed air to facilitate removal of the mandrel.
